(19) United States
(12) Patent Application Publication
(10) Pub. No.: US 2009/0199160 A1
(43) Pub. Date: Aug. 6, 2009

(54) CENTRALIZED SYSTEM FOR ANALYZING SOFTWARE PERFORMANCE METRICS

(75) Inventors: Girish Vaitheeswaran, Fremont, CA (US); Sapan Panigrahi, Castro Valley, CA (US); Daniel Bretoi, Palo Alto, CA (US); Stephen Nelson, San Jose, CA (US); George Wu, Sunnyvale, CA (US)

Correspondence Address: HICKMAN PALERMO TRUONG & BECKER LLP/Yahoo! Inc., 2055 Gateway Place, Suite 550, San Jose, CA, 95110-1083, US

(73) Assignee: Yahoo! Inc.

(21) Appl. No.: 12/023,613

(22) Filed: Jan. 31, 2008

(51) Int. Cl. G06F 9/44

(52) U.S. Cl. 717/124

(57) ABSTRACT

Using a testing framework, developers may create a test module to centralize resources and results for a software test plan amongst a plurality of systems. With assistance from the testing framework, the test module may facilitate the creation of test cases, the execution of a test job for each test case, the collection of performance statistics during each test job, and the aggregation of collected statistics into organized reports for easier analysis. The test module may track test results for easy comparison of performance metrics in response to various conditions and environments over the history of the development process. The testing framework may also schedule a test job for execution when the various systems and resources required by the test job are free. The testing framework may be operating system independent, so that a single test job may test software concurrently on a variety of systems.

### CROSS-REFERENCE TO RELATED APPLICATIONS

This application is related to U.S. patent application Ser. No. ______, Attorney Docket No. 50269-1024, filed on even date herewith, entitled “Executing Software Performance Test Jobs in a Clustered System,” by Girish Vaitheeswaran, et al., the entire contents of which are hereby incorporated by reference for all purposes as if fully set forth herein.

### FIELD OF THE INVENTION

Embodiments of the invention described herein relate generally to software performance testing, and, more specifically, to techniques for generating testing modules and executing testing jobs using said testing modules.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### Performance Testing

Performance testing is an essential aspect of software development. Throughout the software development process, software developers typically test the performance of the various components that comprise their software. Performance testing may alert software developers to potential bugs or inefficiencies in their code. For example, performance testing may expose inefficiencies or unanticipated behaviors that occur with respect to interactions between a software component and one or more tested operating systems, hardware devices, software packages, or network environments. As another example, performance testing may also alert software developers to potential incompatibilities between the various components and applications of their software.

Performance testing typically entails running the software to be tested in a simulated real-world environment under simulated real-world conditions. For example, a developer might test a simple desktop application by running that application on a number of computers and testing that the application responds correctly to a variety of inputs. More complicated software, such as a software suite featuring several load-balanced server applications, might require extensive testing on a number of different systems, each interacting with a large number of simulated clients.

### Test Plans

Because software must typically be tested a number of times throughout development, software developers often create one or more test plans comprising steps and logic for (1) invoking instances of the various software components in the simulated environment and (2) automatically causing the invoked instances to behave in predetermined manners (i.e. the simulated conditions). A software developer may describe such a test plan with, for instance, an execution script comprising code in a scripting language. A process that executes the steps described in a test plan is herein referred to as a “test job.” A test plan may be re-used for test jobs throughout the development process to test the impact of various code changes.

Furthermore, a test plan may include logic for varying the steps of the plan so that the plan may be used to test similar conditions in a variety of environments, or slight variations of simulated conditions in the same environment. The test plan may accept, for instance, input from a command-line interface or configuration file that controls this logic. Also, the test plan may feature logic for detecting the operating environment in which the test plan is being used so as to tailor the plan according to that operating environment. A set of testing parameters that control the environment or conditions tested during a particular test job may be referred to as a “test case.”

### Collecting Performance Statistics

During a test job, a software developer may collect performance-related statistics and events from the various computer systems involved in the test job. Performance-related statistics may include a variety of metrics indicating how certain aspects of a system behave during the test job. Performance-related events may include, for example, software events indicated by debug statements, error statements, or other code-triggered comments. Performance-related statistics and events may be collected by means of logs generated by log-generating components of the system, including profiler utilities, resource monitors, operating systems, the tested software, or any other software package on a tested system. Furthermore, the test plan may itself include steps for outputting performance information to logs. Collecting such statistics manually can be a tedious task, as a developer must search for the relevant logs on each tested system and identify the portions of the logs that pertain to the time during which the test job was being performed on that tested system.

Therefore, software developers typically include steps in their test plans for automating statistic collection. However, these steps may also be tedious to code. For instance, the process for collecting statistics typically varies from operating system to operating system. Furthermore, different systems may run the same operating system, but different log-generating components. Where the tested software is to be deployed on a variety of operating systems, these differences further complicate the task of writing code to automate statistic collection during a test job.

### Other Complications in Performance Testing

Other obstacles add to the complication of testing software during software development. It is often difficult to sift through raw collected statistics to analyze important performance indicators or differences between test cases. Also, test plans are generally very specific to an application or certain types of software, meaning that they cannot be re-used for different software. It is also desirable to schedule test jobs to run using a system scheduler, such as CRON, so that software developers do not have to manually invoke the test jobs they wish to run. However, since test systems are typically used for a variety of test jobs, it is difficult to ensure that a scheduled test job does not overlap with another scheduled test job on a particular system, thereby tainting the performance results.

Because of these and other difficulties in the tasks of implementing code for a test plan, executing test jobs based on a variety of test cases on a variety of systems, collecting statistics from these systems during each test job, and analyzing the collected statistics, software testing is typically either underutilized or labor-intensive, especially for enterprise-level software. It is thus desirable to increase the efficiency of the software testing process.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates a testing framework that may be used to test a software application on a system according to an embodiment of the invention;

FIG. 2 depicts a flow diagram for utilizing a testing framework to perform a test job that tests performance of a software application, according to an embodiment of the invention;

FIG. 3 depicts an exemplary web interface for inputting data to generate a test module according to an embodiment of the invention;

FIG. 4 depicts a web interface for specifying a set of name-value pairs corresponding to test module parameters, according to an embodiment of the invention;

FIG. 5 is an exemplary web interface for tracking a test job queue used by a test scheduler, according to an embodiment of the invention;

FIG. 6 depicts an exemplary web interface for presenting a test result, according to an embodiment of the invention;

FIG. 7 depicts an exemplary web interface for viewing graphical representations of data reports in a test result, according to an embodiment of the invention;

FIG. 8 depicts an exemplary web interface for viewing text-based data in a test result, according to an embodiment of the invention;

FIG. 9 depicts an exemplary web interface for viewing graphical representations of data reports in a test result, according to an embodiment of the invention;

FIG. 10 is an exemplary web interface for building a custom view of data in a test result using a shopping cart model, according to an embodiment of the invention; and

FIG. 11 is block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described herein according to the following outline:
1.0. General Overview
2.0. Structural Overview
3.0. Functional Overview
4.0. Implementation Examples
   4.1. Generating a Test Module
   4.2. Managing Multiple Test Modules
   4.3. Defining a Test Case
   4.4. Invoking a Test Job
   4.5. Scheduling a Test Job
   4.6. Administrating a Test Job
   4.7. Collecting Statistics
   4.8. Generating a Test Result
   4.9. Presenting a Test Result
   4.10. Operating System Independence
   4.11. Real-Time Monitoring
5.0. Implementation Mechanism-Hardware Overview
6.0. Extensions and Alternatives

### 1.0. General Overview

Approaches, techniques, and mechanisms are disclosed for increasing the efficiency of software performance testing processes. According to an embodiment, a user may create a test module to centralize resources and results for a particular test plan. With assistance from the testing framework, the test module may facilitate, for example, the creation of test cases, the execution of a test job for each test case, the collection of performance statistics during each test job, and the aggregation of collected statistics into organized reports for easier analysis. The test module may track test results for each test job executed by the test module to allow for easy comparison of performance metrics in response to various conditions and environments over the history of the development process.

According to an embodiment, a user may create a test module using a test module generator within a testing framework. The test module generator may take, as input, a test plan along with one or more attributes defining parameters for the test module. Based on the test plan and the one or more attributes, the test module generator may generate a test module. The parameters defined by the one or more attributes may correspond to any element of the test plan that may vary. A developer may assign different values to these parameters when creating test cases via the test module. The test module may then execute a test job for the test case.

According to an embodiment, a test module may utilize certain components of a testing framework to perform certain tasks commonly performed during or after execution of a test job, including the generation user interfaces for defining and managing test cases, centralized scheduling of test jobs so that they do not overlap, collection of statistics, aggregation of statistics, and generation of reporting interfaces for reviewing results. The testing framework may comprise components that are capable of performing these tasks independent of the software being tested or the operating environments in which a test job is executed. In so doing, the testing framework greatly reduces the complexity and amount of code required to implement a test plan.

According to an embodiment, a testing framework may be used to execute a test job based on a test case. Details of the test job, based on the test case, are sent to a test administration component for interpretation. The test administration component may schedule the test job for execution when the various systems and resources required by the test job are free. Based on the test details, the test administration component may invoke an execution script comprising the test plan on an execution host, thereby starting the test job process. The test administration component may also invoke log-generating components on systems used during the test job. The test administration component may also provide administrative assistance for the test job. When the test job is complete, the test administration component may activate a statistics collection component to gather logs containing performance statistics. A test result generating component may apply filtering, aggregation, and other operations on these logs to generate test results. The test results may then be presented to a user via an interface generated by a test reporting component.

According to an embodiment, the testing framework may be operating system independent, so that a single test job may test software concurrently on a variety of systems running a variety of operating systems.

In other aspects, the invention encompasses a computer apparatus and a computer-readable medium configured to carry out the foregoing steps.

### 2.0. Structural Overview

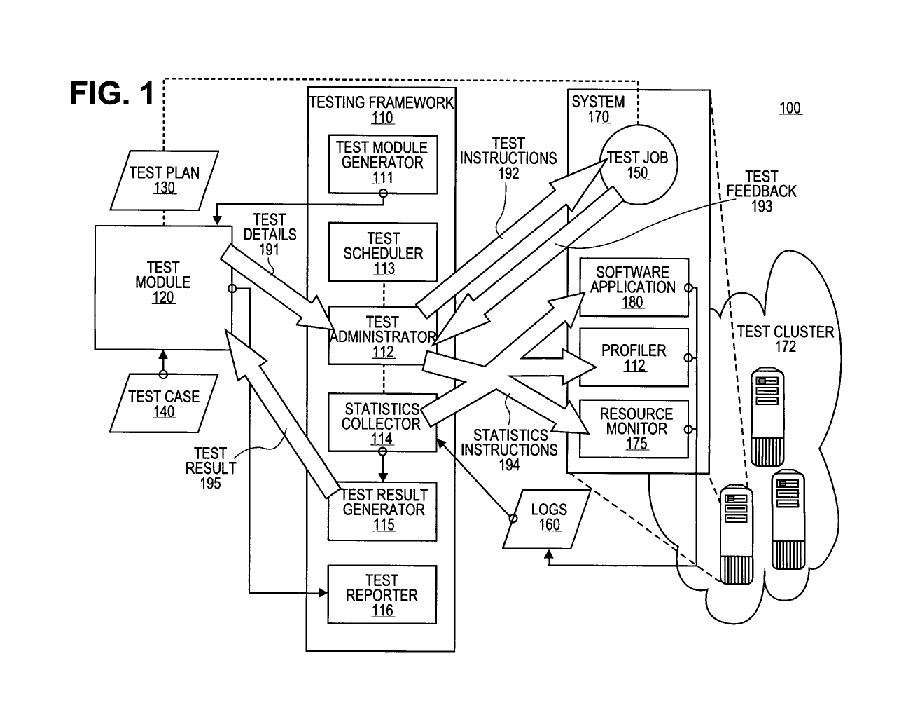

FIG. 1 is a block diagram 100 that illustrates a testing framework 110 that may be used to test a software application 180 on a system 170 according to an embodiment of the invention. The elements of FIG. 1 are exemplary only. Embodiments of the invention may not require every element depicted in FIG. 1.

Testing framework 110 comprises several components. Each of these components may reside on a same computer system—which may or may not be system 170—or on any number of separate computer systems in a test cluster 172 of which system 170 is a member. One of these components is test module generator 111, which may be used to generate test modules such as test module 120.

### Test Modules

Test module 120 is a module that facilitates execution of test jobs, such as test job 150. A user may execute these test jobs to test the performance of software application 180 under varying conditions. Test module 120 may be, for example, a self-contained program unit that has access to testing framework 110. Alternatively, test module 120 may be an instantiation of an object generated by testing framework 110 from stored configuration information.

Test module 120 may be associated with a test plan 130, which comprises steps that may be implemented during any test job for which test module 120 facilitates execution, including test job 150. Test module 120 may directly comprise test plan 130, or it may comprise a pointer to the location of test plan 130. Test plan 130 may be, for instance, in the form of code in a scripting language. This code may be directly executed by a computer system. Test plan 130 may also be in the form of code that can be compiled and then executed by the computer system. Test plan 130 may also be in the form of compiled code that may be executed directly by a computer system. Alternatively, compilation, interpretation, or execution of test plan 130 may be performed by a platform or framework on the computer system, including testing framework 110 itself.

Test module 120 may receive, as input, a test case, such as test case 140. Test case 140 may be received via any type of interface, including a command-line or graphical user interface. For example, test case 140 may be received via input into a web interface for test module 120. A test case may define a set of conditions indicating, for a particular test job, how the test plan will be executed. For example, values from test case 140 may used as input when invoking an execution script containing test plan 130 in order to start test job 150. Test plan 130 may include logic that varies the steps of test plan 130 according to the inputted values. Thus, each test case 140 may result in a different test job 150 that follows different steps and produces different results. As another example, testing framework 110 or test module 120 may comprise logic that varies deployment of test job 150 depending on the conditions specified in test case 140. Test case 140 may also specify how results from test job 150 are to be collected and analyzed.

The conditions specified in test case 140 may be represented in a number of ways, including as name-value pairs. For example, test case 140 could comprise a name-value pair such as “exec_host=10.1.1.15” that identifies system 170 as the computer on which to execute the execution script for test plan 130.

### Test Administration Components

Testing framework 110 may also comprise a test administration component, such as test administrator 112. Test module 120 may send test details 191 to test administrator 112 that describe test job 150. Based on test details 191, test administrator 112 may invoke and supervise execution of test job 150 on system 170. Test administrator 112 may do so using test instructions 192. Test job 150 may also interact with test administrator 112 using test feedback 193.

Test administrator 112 may utilize a test scheduler 113, another component of testing framework 110, to determine when to perform test job 150 so as to avoid overlapping execution of test job 150 on system 170 at the same time as other test jobs. Though depicted as a standalone component of testing framework 110, test scheduler 113 may also be embedded into test administrator 112.

Test job 150 is a process that executes the steps of test plan 130 on system 170. Test job 150 performs test plan 130 under conditions stipulated in test case 140. For example, test job 150 may execute the steps of test plan 130 in an execution script with inputted parameter values derived from test case 140. To the extent that system 170 is responsible for executing test job 150, system 170 may also be referred to as an execution host.

Test job 150 may invoke software application 180 and test its performance under said conditions. Although software application 180 is depicted as residing on system 170, software application 180 may in fact be on any system in test cluster 172. Test job 150 may also invoke other software applications and components.

### Statistics and Results Components

Testing framework 110 may also comprise a statistics collection component, such as statistics collector 114. Statistics collector 114 gathers logs 160 generated during execution of test job 150. Though depicted as a standalone component of testing framework 110, statistics collector 114 may also be embedded into test administrator 112.

To the extent that system 170 generates or stores logs 160, system 170 may be referred to as a statistics host. Logs 160 are records of system events, software events, or values for performance metrics over time. Logs 160 may comprise data in a variety of formats, including CSV, XML, Round-Robin Data Files, and text-based logs. Generally speaking, logs 160 may comprise rows of data, each of which comprising a timestamp and one or more metric values.

Logs 160 may have been generated by a wide variety of components, including software application 180, profiler 175, or resource monitor 176. Profiler 175 may be any known profiler, such as gprof, VTune, or JProfiler. Resource monitor 176 may be system provided, in that it is embedded in system 170's hardware or offered as part of an operating system running on system 170. Resource monitor 176 may also be a process managed by another utility, such as the testing framework itself. Statistics instructions 194 from test administrator 112 or test job 130 may prompt and coordinate generation of logs 160 by these log-generating components.

Logs 160 may also have been generated by test job 150 using steps from within test plan 130, which steps may print debug messages and other comments, as well as access and manipulate data produced by the afore-mentioned log-generating components.

Testing framework 110 may also comprise a statistics aggregation and analysis component, such as test result generator 115. Test result generator 115 may perform a variety of calculations based on logs 160 to produce a test result 155 associated with test job 150. The specific calculations performed may be determined from settings in testing framework 110, test module 120, or test case 140. For example, test result generator 115 may remove any logged data that pertains to a time period prior to the time period designated for logging by test job 150. It may also, for example, aggregate and average data over time or across multiple systems. It may also highlight certain key statistics or trends in the log. Though depicted as a standalone component of testing framework 110, test result generator 115 may also be embedded into statistics collector 114, test module 120, or a test reporter 116.

Test module 120 utilizes test reporter 116 to report information about test result 155. Test reporter 116 may generate a graphical or textual interface capable of displaying logs and graphs of the data in test result 155. For example, test reporter 116 may feature a web interface that allows users to select data reports of individual metrics from test result 155 for graphing. According to an embodiment, such a web interface may be part of a more extended web interface for test module 120 that includes controls for inputting test case 140. Though depicted as a standalone component, test reporter 116 may also be a component of test module 120, or it may be a component of testing framework 110 with which test module 120 interfaces.

### The Tested Software

According to an embodiment, in addition to software application 180 on system 170, test job 150 may invoke any number of components of a software suite on any number of other systems in test cluster 172. In fact, according to an embodiment, test job 150 may only execute software applications and components on systems in test cluster 172 other than system 170, so as to eliminate the possibility of overhead resource consumption in test plan 140 being reflected in the collected statistics. In both cases, statistics collector 114 may collect logs from these systems as well, or the systems may forward their logs to the system upon which test job 150 is executing (i.e. system 170) for collection.

### 3.0. Functional Overview

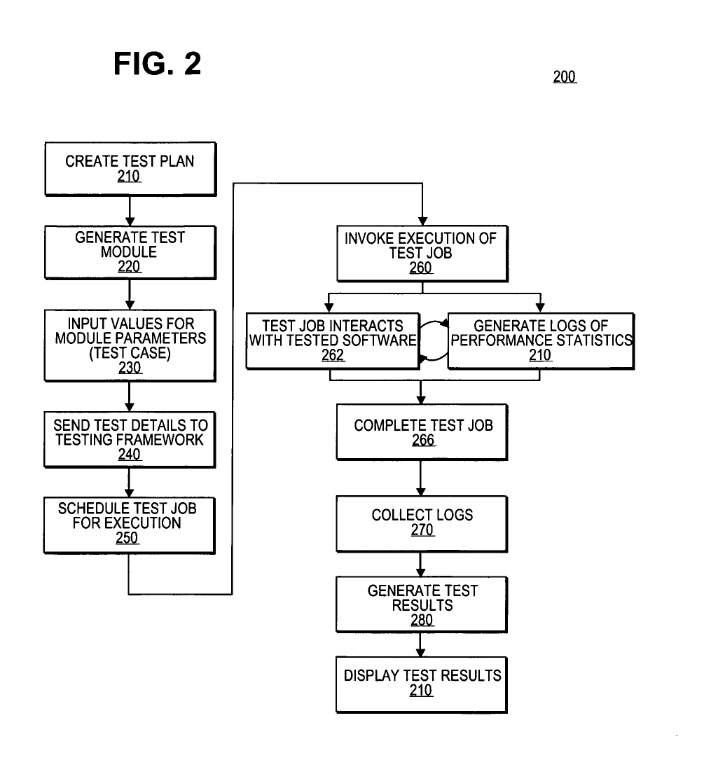

FIG. 2 depicts a flow diagram 200 for utilizing a testing framework, such as testing framework 110, to perform a test job that tests performance of a software application, according to an embodiment of the invention.

### Inputting Test Module and Test Care Information

In step 210, a user creates a test plan, such as test plan 130, for testing the performance of one or more software components, such as software application 180. Because the test plan will be used within the testing framework, the user does not need to include extensive steps for automating the collection, analysis, and reporting of statistics during execution of a test job based upon the test plan. An example test plan is described in section 4.1

In step 220, a user generates a test module, such as test module 120. Example steps for generating a test module using a testing framework are discussed in section 4.1.

In step 230, the user inputs values for the various parameters of the test module, which values form a test case, such as test case 140. Some exemplary steps for inputting these values are discussed in section 4.3.

In step 240, the test module sends data indicating a test job, such as test details 191, to a test administrator or test scheduler within the testing framework. This data may indicate certain details necessary to execute the test job, including, for example, a test plan, one or more systems on which to execute the test plan, one or more systems on which to execute the tested software, one or more systems from which to collect statistics, values for various parameters in the test plan, and types of statistics to gather. The test module may provide default values for these details, or it may determine these details from the values specified for the test case.

### Executing a Test Job

In step 250, the test administrator determines that the resources necessary to execute the test job are free. It may do this, for instance, using a test scheduler that monitors test jobs executing on the each system in a cluster of testing systems, such as test cluster 172. Example techniques for scheduling a test job are discussed in section 4.5.

In step 260, the test administrator invokes execution of the test job. Example techniques for invoking a test job are discussed in section 4.4.

In step 262, the test job interacts with the one or more software components, such as software application 180, being tested on one or more systems. For example, the test job may invoke an instance of a server software component on one system along with an instance of a client software component on another system. As another example, the test job may send commands or data to an already-running client software component instructing it to make certain requests of an already-running server software component.

The test job may carry out this interaction in accordance with predefined logic in the test plan. For example, the test job may invoke instances of software components with command-line settings identified by logic in the test plan. The test job may also carry out this interaction in accordance with logic in the test plan that varies according to instructions received from the test administrator, such as test instructions 192. These instructions may have been received either in step 260, or as part of continued interaction with the test administrator, as discussed below. For example, the test job may input a data file into a software component for evaluation. It may determine the data file based on logic in the test plan that translates a certain name-value pair inputted during invocation of the execution script for the test plan into an identification of a location for a text file.

As part of this step, the test job may require interaction with the test administrator as well. For example, the test job may need to solicit instructions regarding a backup system on which to invoke a software component in the event of a system failure. Or, the test job may need to message the test administrator to advise it that it has entered certain phases of the test plan. It may do so, for example, with test feedback 193. Exemplary interactions between a test job and a test administrator are discussed in section 4.6.

In step 264, which may happen concurrently with step 262, logs, such as logs 160, are generated by any of a number of various components on the systems involved in the test job. These logs may be generated by, for example, the test job itself, tested software components, system profilers, system resource monitors, or any other system or component capable of generating logs of performance metrics.

In step 266, the test job is completed. As a final step of the test job, the test job may signal to the test administrator that it has completed execution. Alternatively, the test administrator may discover that the test job is completed through regular monitoring of the test job process.

### Reporting Test Results

In step 270, the statistics collector collects the logs generated in step 264. This step may be performed in response to the test administrator determining that the test job is complete. Alternatively, the step may be performed throughout the test job (i.e. concurrently with steps 262-264). Exemplary methods for collecting these logs are discussed in section 4.7.

In step 280, a test result generator generates a test result based on the collected logs. It may send the test results to back to the test module, where they are associated with the original test case. It may generate a test result by, for example, aggregating and analyzing the collected logs to identify key statistics, significant results, average resource usage, or outlying performance indicators. The test result generator may also, for example, remove irrelevant statistics, such as statistics pertaining to time periods leading up to the moment at which the various software components invoked by the test job were in a steady state (i.e. they moment at which the software had successfully “started up” and was ready for testing). Exemplary techniques for test result generation are discussed in section 4.8.

According to an embodiment, the logged data may also be sent directly to the test module, which may itself aggregate and analyze the data to produce some or all of the test result.

In step 290, the test module displays the test result to the user. For example, the test module may present graphs, tables, or plain text views of the data in the test result. It may do so using a textual or graphical interface, such as an interactive web interface that provides controls for filtering or selecting various data elements in the test result. Exemplary techniques for presenting a test result are discussed in section 4.9.

The steps of flow diagram 200 are exemplary only-embodiments of the invention may feature a number of variations on these steps, both in order and in implementation. For example, a test module might invoke execution of a test job directly, instead of requiring steps 240 and 250. Or, the test administrator may not use a scheduler, thus eliminating any need for step 250.

### 4.0. Implementation Examples

### 4.1. Generating a Test Module

A user may utilize a testing framework, such as testing framework 110, to generate a test module, such as test module 120, for a test plan, such as test plan 130. To do so, the user may send data indicating characteristics of the desired testing module to a test module generator in the testing framework, such as test module generator 111.

### Example Test Plan

As previously mentioned, a user may represent a test plan in a variety of forms. The PERL code below, stored in an execution script named simple_script.pl, is one such example representation. Specifically, the code below is a simple test plan that involves testing the performance of a file copy command.

```
#!/usr/bin/perl
use strict;
use warnings;
use Fatal;
use File::Copy;
MAIN: {
    my ($file, $number_of_times) = @ARGV;
    # Say when the actual testing started
    send_feedback(‘START_EXECUTION’);
    # Run our command multiple times
    for (0 .. $number_of_times) {
        copy($file, “file_copied”)
            or die “Couldn't copy ‘$file’ to ‘file_copied’: $!’”;
    }
    # Say when the actual testing ended
    send_feedback(‘END_EXECUTION’);
}
sub send_feedback {
    my ($file) = @_;
    open(my $fh, ‘>’, “log/$file”);
    print $fh time( ), “\n”;
    close($fh);
}
```

### Test Module Generation Data

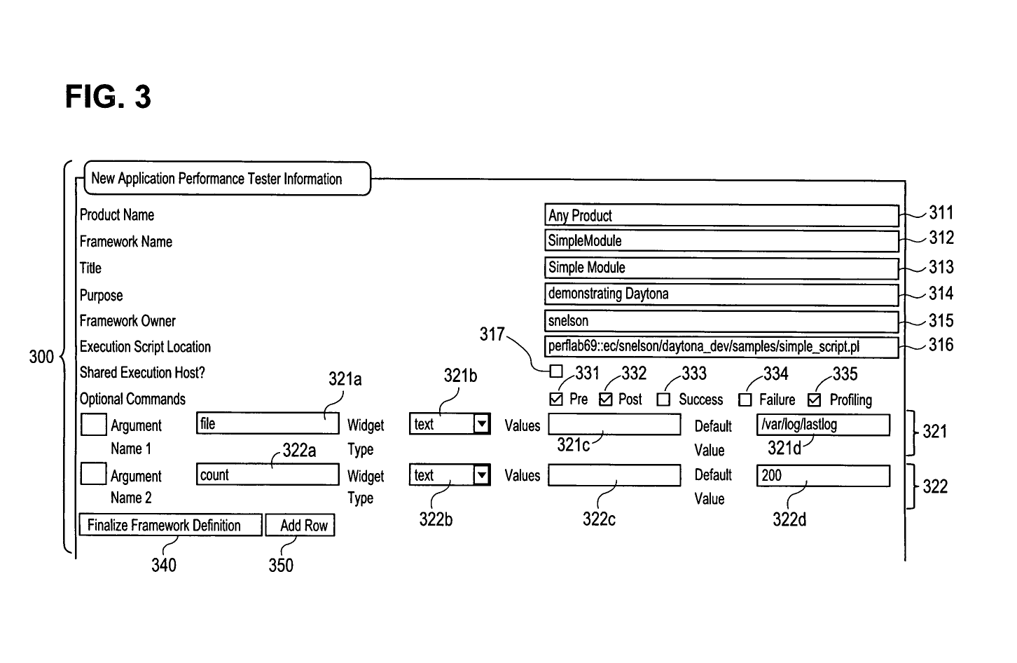

A user may send data that indicates characteristics of a testing module using a variety of means, including textual or graphical interfaces. FIG. 3 is one such interface. FIG. 3 depicts an exemplary web interface 300 for inputting data to generate a test module according to an embodiment of the invention. Web interface 300 may be generated by the test module generator or another component of the testing framework.

The data sent to the test module generator may include data identifying a test plan upon which all test jobs executed by the test module should be based. For example, as depicted by textbox 316, a user might identify a test plan by specifying the location of an execution script or other resource containing the steps of the test plan. Alternatively, the data sent to the test module generator may include data specifying the actual steps of the test plan.

### Attributes for Test Module Parameters

The data sent to the test module generator may also comprise one or more attributes for parameters to the test module. Controls 321 and 322 illustrate one method for specifying such attributes. Based on these attributes, the test module generator may incorporate customizable parameters into the test module. For example, a user might specify an attribute using control 322. The user might specify an attribute name of “count,” as depicted in field 322a. The test module generator might incorporate this attribute into the test module as a similarly-named parameter for setting the number of times a test job iterates through functionality tested by the test plan.

According to an embodiment, an attribute may include information that specifies a default value for a parameter. For example, the user may specify an attribute such as “% NUM_STATS_HOSTS %=100,” which the test module generator may incorporate into the test module as a NUM_STATS_HOST parameter, whose default value is 100. As another example, field 322d of web interface 300 is a control for specifying default values for the “count” attribute inputted via control 322. Additionally, an attribute may include information specifying whether or not a test case may change the value for this parameter, such as a label indicating that the value is “locked.”

According to an embodiment, each attribute may include information specifying a control type to be used for selecting a value for the parameter that will be generated for the attribute. Example control types may include standard HTML form controls, such as textboxes, checkboxes, or drop-down lists. This control information may be used by the test module to generate an interface for the parameter, as discussed in section 4.2 below. For example, control 322 of web interface 300 comprises a field 322b that permits selection of various control types that may be used for the “count” attribute.

Each attribute may also include information enumerating a list of possible values for the attribute. For example, an attribute defining a parameter named “Sample Input File” might include an enumerated list of several files that could be selected for use during the test job. As another example, field 322c of web interface 300 allows a user to input a comma separated list of potential values for the “count” attribute.

Also, each attribute may include information specifying, in addition to the internal name by which it will be known to the testing framework, a title by which it may be presented in an interface. Also, each attribute may contain logistical information specifying how the attribute should be used, such as whether it should be sent as a parameter value for the execution script, whether it is a command that should be run prior to the test job, whether it is a command that should be run after the test job, and so on.

Button 350 is a button that, when clicked, allows a user to add additional attributes.

Although the potential uses for these attributes are endless, common purposes for these attributes may include defining parameters or setting default values for any of the following operating conditions of a test job: the number of users to simulate, the system or systems on which to execute the test job, the location of a system or systems on which to invoke various software components involved in the test job, commands to run before and after execution of a test job, a server load level, the number of queries to test, the type of data to collect, the number of lines of data in a tested data file, the location of a test data file, one or more statistics-gathering systems, under what conditions profiling should be enabled, and ways to present collected data.

### Additional Test Module Generation Information

Web interface 300 includes a number of controls for specifying additional information for test module generation. Control 311 is a text box for inputting a product name of the software being tested. Control 312 is a text box for inputting an internal name for a test module, by which it may be known to the testing framework. Control 313 is a text box for inputting a module title, by which the test module may be known to users. Control 314 is a text box for inputting a description of the test module, so that a user may easily determine the purpose of the module. Control 315 is a text box for inputting a user name identifying an owner for the module. This owner may be able to assign permissions to other users for accessing the test module. Control 317 is a checkbox that, when checked, indicates that the test module may share an execution host with other test jobs concurrently.

Control 331 is a checkbox that enables the test module to invoke certain commands prior to executing the test job. Control 332 is a checkbox that enables the test module to invoke certain commands after executing the test job. Control 333 is a checkbox that enables the test module to invoke certain commands in the event of an error during a test job. Control 334 is a checkbox that enables the test module to invoke certain commands in the event that the test job reports that it has executed successfully. Control 335 enables profiling during execution of test jobs based upon the test module.

### Submitting the Data and Creating the Test Module

Button 340 allows a user, having specified a test plan in box 316 and attributes in controls 321 and 322, to send the specified data to the test module generator for processing. Upon receiving the specified data, the test module generator may generate a test module based on the specified data.

According to an embodiment, the test module generator may generate the test module in the form of code or a compiled executable. The code or compiled executable may be standalone, or may rely upon libraries exposed by the testing framework. The user may execute the code or executable whenever the user wishes to access test module functionality or interfaces.

According to an embodiment, the test module generator may instead represent the test module as data in a database or file system accessible to the testing framework. To access the test module, the user may issue a command to the testing framework to instantiate the test module. The testing framework may instantiate the test module based on the representing data in the database or file system.

### Default Parameters

According to an embodiment, the test module generator may also generate additional parameters for the test module that are not based on any received attributes. For example, in the absence of an attribute identifying a system on which to execute the test job, the test module generator may incorporate into the test module a parameter for selecting one of any number of default systems on which to execute the test job.

### Test Module Templates

According to an embodiment, a user may define a test module to be a test module template. When creating subsequent test modules, the user may indicate that the user wishes to build a test module using the test module template. Test modules built upon the same test module templates may share an inheritance relationship with the test module template. Any attributes defined for the test module template will automatically be pre-set in the subsequent test module. The user may then change the attributes as he or she wishes before generating the test module. Alternatively, the template-based attributes in the subsequent test module may be locked, so that a user may not change them.

According to an embodiment, an inheritance relationship between a test module and a test module template may last throughout the lifetime of the test module. Thus, if an attribute is ever modified for the test module template, the attribute may also be modified for the test module. This may require the test module to be re-generated.

### 4.2. Managing Multiple Test Modules

A user may generate any number of test modules for any number of software applications or software suites. In fact, because a user may have multiple test plans for testing performance in regards to different aspects of a software application, the user may generate any number of test modules for any given software product. To help a user keep track of the generated test modules, the testing framework may provide a test module management interface for accessing, updating, and deleting test modules. This interface may list all test modules generated by the testing framework, and may arrange them by, for instance, product name of the software that they test, such as the product name specified in control 311 of web interface 300.

### 4.3. Defining a Test Case

Once a test module has been generated, a user may start a test job using the test module. To do so, the user may first send a set of one or more name-value pairs to the test module. The name in each name-value pair may correspond to a same-named parameter of the test module. This set of one or more name-value pairs may be considered a test case, such as test case 140. The user may send this test case to the test module using a variety of interfaces, both graphical and textual. For example, the user may define a number of test cases in a database or structured data file, which may then be read by the test module all at once, or one-by-one according to an automated schedule.

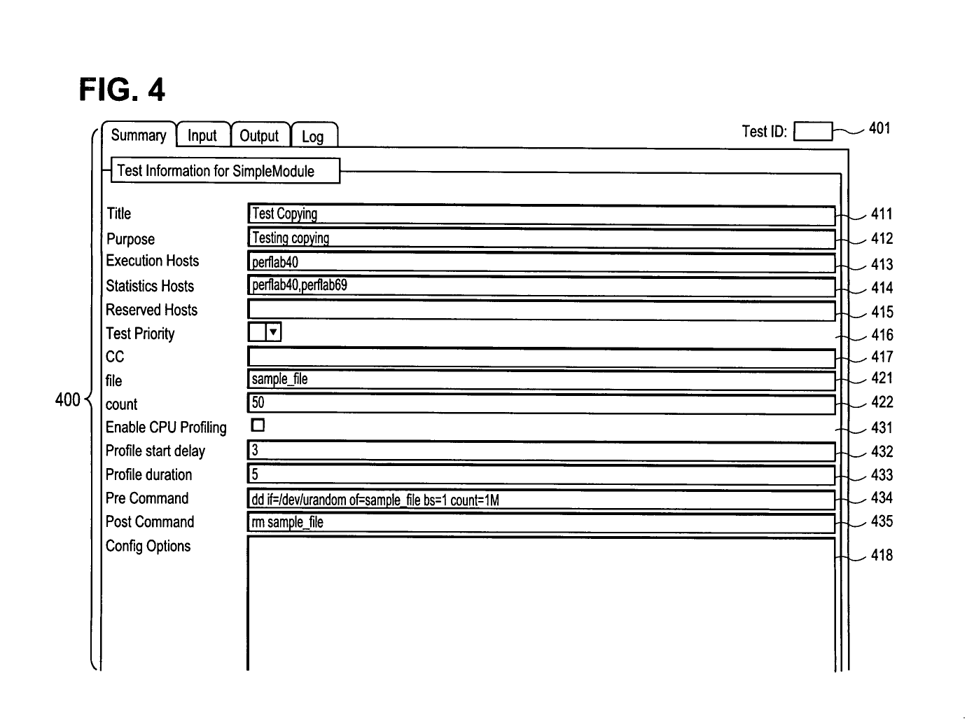

As another example, FIG. 4 depicts a web interface 400 for specifying a set of name-value pairs corresponding to test module parameters, according to an embodiment of the invention. Web interface 400 comprises controls 410, each of which are associated with a parameter. For any control 410, a user may specify a value. The test module may then use this value along with the name of the associated parameter as a name-value pair for the test case.

Some of the parameters for which values are solicited in web interface 400 may correspond to the parameters incorporated into the test module by a test module generator, using the techniques explained in section 4.1. For example, control 322 in FIG. 3 is depicted as accepting as input an attribute named “count.” As explained is section 4.1, this attribute may be used to incorporate a parameter named “count” into the test module. As specified in field 322b, input for the count parameter in web interface 400 is solicited in a text box control. Specifically, web interface 400 comprises a control 422 for receiving input corresponding to this incorporated parameter. Likewise, web interface 400 contains a control 421 that corresponds to value inputted for control 321 of web interface 300.

Other parameters for which values are solicited in web interface 400 may have been derived from other attributes specified in web interface 300 during test module generation. For example, controls 431, 432, and 433 solicit values for enabling profiling, a profile start delay, and a profile length, respectively. These controls may have been generated in response to a user having checked box 335 in web interface 300, thereby sending an attribute for test module generation indicating that profiling should be enabled for the test module. Likewise, controls 434 and 435, which solicit values for commands to start prior to and after the test job, may have been derived in response to a user having checked boxes 331 and 332, respectively, in web interface 300.

Other parameters for which values are solicited in web interface 400 may be provided universally for any test module. The following controls in web interface 400 are examples of such universal parameters: control 411, specifying a user-readable title for the test case; control 412, specifying a user-readable description for the test case, so as to help a user quickly identify the purpose of the test case; control 413, specifying the names or addresses of one or more execution hosts, each separated by a comma; control 414, specifying the names or addresses of one or more statistics hosts, each separated by a comma; control 415, specifying the names or addresses of one or more reserved hosts, each separated by a comma, and each of which must not be used by any other test job in order for the test job identified by this test case to run; control 416, specifying a priority for the test job, which priority a scheduler, such as test scheduler 113, may take into account when scheduling the test job; control 417, specifying a CC command; and control 418, specifying additional configuration options that may be passed as parameters to an execution script used to carry out the test plan associated with the test module.

Control 401 is another example of a universally provided parameter. Control 401 allows a user to specify a test case identifier for this test case, which identifier may be used to represent the test case internally in the test module and in the testing framework. If this value is left empty, the test module may assign a default name.

Web interface 400 may also include a button which, when clicked, will send all of the values specified in controls 410, along with the corresponding field name for each value, to the test module as a test case.

### Test Case Templates

According to an embodiment, a user may define a test case to be a test case template. When creating subsequent test cases, the user may indicate that the user wishes to build a test case using the test case template. Test cases built upon the same test case template may share an inheritance relationship with the test case template. Any values defined for the test case template will automatically be pre-set for the same parameters in the subsequent test case. The user may then change the values as he or she wishes. Alternatively, the template-based values in the subsequent test case may be locked, so that a user may not change them.

### 4.4. Invoking a Test Job

According to an embodiment, upon receiving a test case, such as test case 140, a test module, such as test module 120, may indirectly invoke execution of a test job, such as test job 150. To do so, the test module may send details about the test job, such as test details 191, to a test administration component, such as test administrator 112. The test module may send these test details in a number of ways, such as over a dedicated port opened by the test administrator or as rows inserted into a database to which the test administrator has access. The test administrator may then determine how and when to invoke execution of the test job.

### Test Details

The test module may send these test details immediately to the test administrator upon receiving a test case. Alternatively, it may wait for additional input before sending the test details. For example, the test module may comprise means for storing a number of received test cases, each of which may be associated with an identifier. This identifier may have been assigned by the test module when the test case was received, or by values inputted as part of the test case itself. When a user wishes to invoke execution of a test job according to one of these stored test cases, the user may send input indicating the identifier for the desired test case.

The test details may indicate to the test administrator information about how to execute the test job or how to generate and collect results for the test job. This information may include, for example, the test module's test plan along with one or more attributes reflecting name-value pairs specified in the test case or hard-coded into the test module. The information in the test details may also include other instructions that the test module may have derived from the test case, or that have been hard-coded into the test module.

Upon receiving the test details about a test job, the test administrator may determine how to invoke, administer, and collect results from the test job using the test details. For example, the test administrator may look in the test details for an attribute with a certain pre-defined name or for a certain pre-defined instruction that identifies prerequisites to load on systems before invoking the test job. As another example, the test administrator may search for an attribute or instructions that indicate command line parameters to be used when invoking the test job. If the test details do not include instructions or attributes corresponding to required details for the test job, the test administrator may determine the required details from default instructions provided by the testing framework.

### Invoking an Execution Script on the Execution Host

According to an embodiment, one detail that the test administrator may determine is the location of one or more systems, such as system 170, on which to invoke execution of the test job. Such a system may be referred to as an “execution host.” For example, the test administrator may find an attribute in the test details comprising a name-value pair such as “exec_host=10.1.1.15.” From this name-value pair, the test administrator may determine that the system whose IP address is 10.1.1.15 should be used as an execution host.

As another example, the test administrator may find in the test details instructions to use, as execution hosts, any two available systems with certain requisite features, such as a certain amount of installed memory, certain installed software, or a certain number of processors. The test administrator may determine two execution hosts from these instructions by consulting information the test administrator has acquired about the features of one or more designated testing systems to which the testing framework has access. It may also monitor resource usage on these designated testing systems to determine which systems are currently available. The designated testing systems may have been designated through a configuration interface for the testing framework, or may have been designated by virtue of their connection to a test cluster.

In order to invoke execution of the test job on the execution host, the test administrator may send test instructions, such as test instructions 192, to the execution host. These test instructions may be interpreted by the execution host in such a manner as to cause the execution host to begin executing the test job. For example, the test instructions may include a command-line statement that references, by name, a script or executable file containing the steps of the test plan. Such a script or executable file may also be known as an “execution script.” The test administrator may send the test instructions to the execution host using a variety of mechanisms, including a remote procedure call, commands in a secure shell or telnet session, or commands over a dedicated port operated by a testing framework-administered process.

If the execution host is non-responsive to the test instructions, or if the execution host sends test feedback indicating that it is unable to perform the test job, the test administrator may take one of several actions. One action the test administrator could take is return test results to the test module indicating that the test job failed. Another action the test administrator could take is to look for information in the test details indicating one or more backup execution hosts on which it may invoke the test job instead. Alternatively, the test administrator could select a backup execution host from a default list of execution hosts defined for the testing framework. Another action the test administrator could take is to look for an alternative system accessible to the testing framework that possesses qualities similar to those of the execution host, and attempt to use the alternative system as an execution host.

Once an execution host has received a message with instructions to invoke a test job, it may do so using whatever means are appropriate for the execution script that contains the test job's test plan. For example, if the test plan is written in Java or C++, the execution host may compile the execution script and then run it. If the test plan is written in an interpreted language, such as in a shell script or PERL script, the execution host would immediately begin interpreting the execution script.

### Additional Information in the Test Instruction

The test instructions may include other information. For example, the test administrator may include, as part of the command-line statement that starts the execution script, name-value pairs corresponding to parameters for varying the test plan. For example, if the execution script were named “testscript.pl,” the command that invokes the execution script might be: “testscript.pl-load 1000”, where “-load 1000” sets the value of a parameter named “load” in the test plan to 1000. The test administrator may determine the name-value pairs to input into the test plan using the test details it received from the test module. According to an embodiment, the test administrator may include all name-value pairs it received in the test details as part of the invoking command-line statement. Alternatively, it may only send the name-value pairs of attributes that are not otherwise used for pre-defined testing framework functionalities.

For execution scripts that only accept parameter values over the command line instead of name-value pairs, the test administration may include in the command-line statement values only. For example, consider the parameters corresponding to controls 421 and 422 of web interface 400 of FIG. 4. The test module may have sent attributes to the test administrator that include the names of and values specified for these two parameters. The test administrator, however, may not have any functionality associated with a count or file attribute. Consequently, the test administrator may pass the values of the count and file attributes in the command line for executing the execution host. The values may be passed in the order they were listed. Thus, since the execution script specified in web interface 400 was simple_script.pl, the invoking command might be “simple_script.pl sample_file 50.” The simple_script.pl contains a test plan configured to automatically recognize these values as values for the $ file and $ number of_times variables, respectively.

The test instructions may also include other commands. For example, the test instructions might include commands that prepare the system's environment for the specific test job. Such commands might set environment variables, reserve resources on the execution host, start required processes, or make sure that resource dependencies have been satisfied. In fact, the test administrator may include commands that copy or install necessary resources if the necessary resources are not on the execution host. For example, the test administrator could copy the execution script to the execution host if the execution host did not have access to it. The test administrator could also issue a command to compile the execution script, if necessary. As another example, the test administrator could issue a command to install certain packages that the test job requires on the execution host, as described in section 4.6.

The test administrator may derive yet other commands for inclusion in initialization test instructions using the attributes it receives in the test details. For example, the test administrator might determine that an attribute with a certain pre-defined name comprises one or more commands to be executed before the execution script on the execution host. The pre parameter of control 434 is an example of one such attribute. This strategy may be extended to commands that may be issued in test instructions at times other than before starting the execution script. For example, the test administrator may look for logistical information associated with an attribute that (1) indicates that the value of the attribute is a command to run on the execution host; and (2) identifies one or more conditions for running the command, such as before or after the test job, or upon success or failure of the test job.

### Variations

According to an embodiment, rather than submit certain name-value pairs as input to the execution script's parameters, the test administrator may save the certain name-value pairs to the execution host in a configuration file accessible to the execution script. Alternatively, the execution script may comprise logic for sending test feedback, such as test feedback 193, to the test administrator. This test feedback may comprise a request that the test administrator send subsequent test instructions indicating values for certain parameters.

According to an embodiment, the test module may instead invoke execution of the test job directly, using much the same process as the test administrator uses to invoke the test job. Upon receiving a test case, the test module may immediately invoke execution of a test job based upon its test plan and the test case. Alternatively, the test module may wait to invoke a test job for a received test case until it has received a command to do so.

According to an embodiment, a test administrator may itself run the steps of the test plan, instead of invoking the execution script on an execution host.

### 4.5. Scheduling a Test Job

According to an embodiment, rather than invoking a test job immediately upon receiving test details, a test administrator may schedule the test job for later execution using a scheduling component, such as test scheduler 113. To do so, the test administrator may relay certain scheduling details to the test scheduler. The test administrator may derive these scheduling details from the test details, or, in the absence of information in the test details sufficient for deriving scheduling details, it may relay default scheduling details.

The scheduling details may include, for instance, a start time and a test case identifier. The test administrator may derive the start time and test case identifier from a start_time attribute and a test_id attribute in the test details, which in turn may reflect name-value pairs from the original test case. The scheduling details may also include resource usage information, identifying resources necessary for the test job. For example, the scheduling details may define specific systems that will be involved in the test job, including execution hosts, statistics hosts, and reserved hosts. However, some embodiments may not require that an execution host be entirely free, if, for instance, the test module was generated with a shared execution host setting enabled.

Upon receiving scheduling details, the test scheduler may store the scheduling details a job queue along with previously received scheduling details for other test jobs. This job queue may reside in, for instance, a database accessible to the testing framework. The test scheduler may routinely monitor the queue to determine if the test administrator should be notified that it is time to start a certain test job. For example, if the scheduling details for a test job indicate a particular start time, and the current system time is equal to or past the particular start time, the test scheduler may notify the test administrator that it is time to start the test job.

As another example, the scheduling details for a test job may include resource usage information, such as information indicating that the test job requires systems X, Y, and Z. The test scheduler may compare that resource usage information against resource availability information to determine if the necessary resources are available for the test job. For example, the test scheduler may store information indicating which systems are currently running test jobs. Or, the test scheduler may monitor processes and processor usage on each system accessible to the testing framework. If the resource availability information indicates that systems X, Y, and Z are all available, the test scheduler may determine that it is time to start the test job.

The test scheduler may also use start time information in conjunction with resource usage information to determine when to run the test job. Thus, the test scheduler might determine that it is time to start a test job only when the resources it needs are available after the test job's designated start time.

When the test scheduler determines that it is time to start a test job, it may notify the test administrator that it is time to invoke the test job. Upon receiving such a notification, the test administrator may then invoke the test job as discussed in section 4.4. Such a notification may take the form of a test case identifier, in which case the test administrator uses the test case identifier to retrieve the test details for the test from a store containing previously received test jobs. Alternatively, the scheduling details may have included all of the test details for the test job. The scheduler may resend these test details to the test administrator for immediate processing.

### Variations

According to an embodiment, the scheduling details may define qualities and quantities of systems necessary for the test job. When the scheduler determines that the requisite quantity of systems with the requisite qualities and resources are available, the scheduler may determine that it is time to start the test job. As part of its instructions to the test administrator, the scheduler may then define exactly which systems are available. The test administrator may then use this information in administering the test job—for example, it may use this information to identify one or more execution hosts and one or more statistics hosts. The test administrator may also send this information as part of the initial test instructions to the execution host, so that the test job may determine one or more available systems on which to execute various components of the software being tested.

According to an embodiment, the test scheduler may use conflict resolution and resource usage optimization routines to ensure that multiple test jobs in the test job queue are executed in a timely and efficient manner. The test scheduler may also utilize prioritization information in the scheduling details. So, for example, the test scheduler may be able to push a prioritized test job through the queue more quickly than it normally would have gone through the queue.

According to an embodiment, the test scheduler may reserve resources indicated by the resource usage information for future use, so as to ensure that a test job will have adequate resources. For example, the test scheduler may reserve a set of systems for use at a test job's start time, thereby ensuring that no other processes will be utilizing the system's resources at that time. As another example, the test scheduler may send instructions to a system to forbid new test jobs from using that system until a particular test job has finished using that system.

According to an embodiment, the test scheduler is able to routinely monitor the queue of test jobs because it is a continuously running process. Alternatively, the test scheduler may be regularly invoked by a system scheduler, such as CRON. Each time the test scheduler is invoked, the test scheduler may, for each test job in the job queue, examine the test job's scheduling details in order to determine if it is time to start the test job. It may also use these scheduling details to determine at what time the system scheduler should next invoke the test scheduler.

According to an embodiment, the test module may send test details to the test administrator via the test scheduler, rather than directly to the test administrator. For example, the test module may directly insert the test details into one or more rows in a database maintained by the test scheduler. Using the test details, or using default information in the case that the test details offer no indication of a starting time or necessary resources, the scheduling component may determine when to start a test job based on the test details. It may then relay the test details to the test administrator or otherwise instruct the test administrator on how to find the test details.

According to an embodiment, each execution host may run its own test scheduling and test administrative processes. In this manner, the testing framework may ensure that the failure of one system will not result in the loss of all test jobs in the testing framework. The separate test scheduler and test administrative processes may work in tandem with the testing framework's central scheduler and test administrator for redundancy.

### Interface for Tracking the Test Job Queue

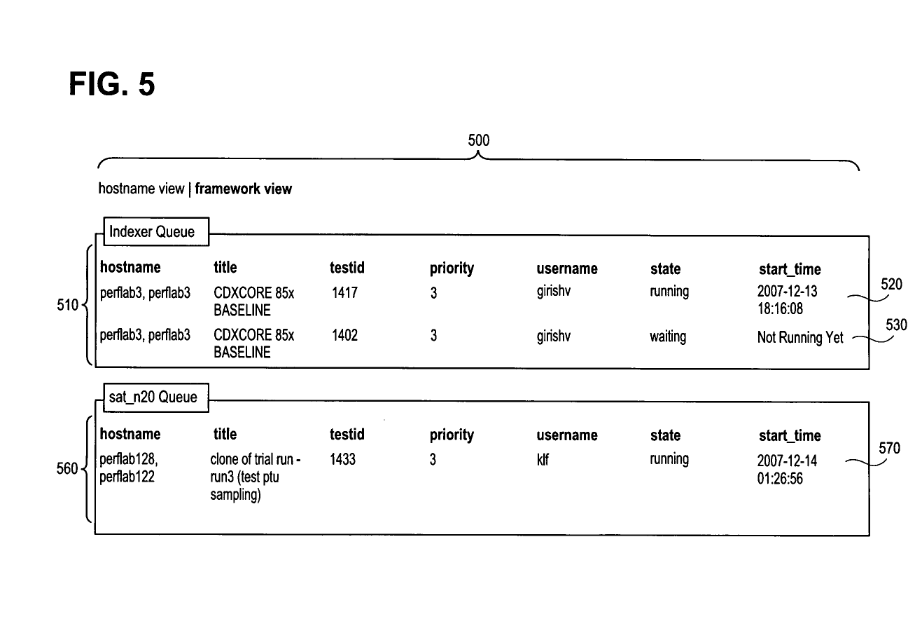

FIG. 5 is an exemplary web interface 500 for tracking a test job queue used by a test scheduler, such as test scheduler 113, according to an embodiment of the invention. Web interface 500 may be provided by the test scheduler or another component of the testing framework.

Web interface 500 comprises tables 510 and 560, associated with test modules named Indexer and snt_a20 respectively. Table 510 comprises rows 520 and 530, while table 560 comprises row 570. Rows 520 and 530 correspond to test jobs the Indexer test module, the test jobs having identifiers of 1417 and 1418. Row 570 corresponds to a test job for the snt_a20 module having an identifier of 1433.

The status columns for row 520 indicates that test job 1417 is currently executing, while the status column for row 530 indicates that test job 1418 is currently waiting to execute. In fact, test job 1418 will wait for execution until test job 1417 finishes executing, because, as the hostname column for each of rows 520 and 530 indicates, test job 1418 defines at least one necessary resource in common with test job 1417. Meanwhile, as indicated by the status column of row 570, test job 1433 is executing even though it started after test job 1417 because, as indicated by the hostname column, test job 1433 does not list any necessary resources in common with test job 1417.

According to an embodiment, web interface 500 might contain controls to force a status change for one or more test jobs in the test job queue. Also, web interface 500 might contain controls for changing the value in priority column of each of rows 520, 530, and 570.

### 4.6. Administering a Test Job

Once the execution script for a test job has been started on an execution host, the execution host will execute the various steps of the test plan in accordance with any values it received as input to the execution script's parameters. As previously mentioned, the test job may perform any number of tasks to test software performance, such as invoking or sending input to various software components. Once started, the execution script may proceed largely without input from the test administrator.

In some circumstances, however, the test administrator may need to perform certain administrative tasks to assist the test job. In these circumstances, the test plan may be designed to send testing feedback, such as test feedback 193, to the test administrator, indicating that the test job requires performance of an administrative task.

### Providing Additional or Backup Parameter Values

One administrative task that the test job might request the test administrator to perform is to provide additional test details that may not have been provided in the initial test instructions. For example, the test administrator may not have submitted values for each of the parameters required for the test plan. The test job may submit test feedback requesting a value for a certain parameter. This test feedback may be submitted, for instance, via a dedicated port used by the test administrator or an API to the testing administrator exposed by the testing framework. The test administrator may return the corresponding values through test instructions over the dedicated port.

As another example of an administrative task, the test plan may require use of a system that is presently unavailable. The test job may, in response to detecting that the system is unavailable, submit test feedback requesting that the test administrator identify another system that the test job could use. The test administrator may be able to locate a suitable system using, for example, a list of backup systems identified in the test details or a default list of backup systems specified for the testing framework. Alternatively, the test administrator may identify another system to which the testing framework has access that is similar in configuration to the unavailable system. Another alternative may be for the test administrator to consider the test job failed and return test results indicating the failure.

As another example of an administrative task, the test plan may know that it needs a certain number of statistics hosts, but be unaware of where available statistics hosts may be located. It may send feedback to the test administrator requesting allocation of a certain number of statistics hosts. The test administrator, possibly in conjunction with the scheduler, may allocate the certain number statistics hosts from the set of free systems in the test cluster. The test administrator may return test instructions identifying each of the allocated statistics host. The test administrator may also perform various initializing tasks for the allocated statistics hosts.

### Resource Dependency Tasks

Another example of an administrative task that the test administrator may perform is resource dependency management for the systems involved in the test job. The test administrator may perform this task both on its own initiative prior to invoking the test job and at the request of the test module. To perform this task, the test administrator needs to be aware of at least some of the systems that will be involved in the test job, as well as at least some of the resources that are needed for the test job.

Prior to invoking the test job, the test administrator may utilize the test details it receives for a test job to determine said systems or resources. For example, the test details may contain instructions or attributes that explicitly specify said systems and resources. Alternatively, the test administrator may be able to discern at least some of this information by analyzing the test plan or the code for the tested software. Also, the test administrator may guess some of the resources that a test job may require based on a default resource list for the testing framework. This default resource list may be defined specifically for the tested software, specifically for a coding language used by the test job, or generically for all test jobs.

Subsequent to the test administrator invoking the test job, the test job itself may send test feedback to the test administrator identifying one or more systems on which the test administrator should assure that certain resources are available. The test plan may contain logic for sending this test feedback via, for example, a dedicated port or API to the test administrator.

Upon determining or receiving instructions indicating one or more systems on which to ensure that one or more resources have been installed, the test administrator may use several methods to ensure that the one or more resources will be available on the indicated system or systems. If an indicated resource is a software application or package, for instance, the test administrator may contact a package management component on an indicated system and request that the package management component identify what version (if any) of the software application or package is installed. Such a package management component may be provided by the indicated system's operating system, provided by a development platform installed on the indicated system, or otherwise installed on indicated system. If the package management component indicates a version that is insufficient for the test job, or that no such software is installed, the test administrator may send instructions to the package management component that will cause it to install the desired version of the software application or package. It may also instruct the package management component to install any other versions of other software applications or packages upon which the desired version of the indicated software application or package may be dependent.

Other examples of resources that the test administrator may ensure are available on an indicated system include test files and databases. For example, the tested software may make use of certain files to perform tested functionality. These files might configure the tested software, be processed as inputs for the tested software, or otherwise control the behavior of the tested software. The test administrator could copy test versions of these files to the indicated system. As another example, the tested software may process data from a database. The test administrator could ensure that a certain set of test data exists in the database on the indicated system.

Alternatively, the test administrator may take more direct steps to ensure that resources are installed on the indicated system. It may, for instance, attempt to discover the version of a software application that is installed by analyzing information in the indicated system's registry or file system. Or, it may attempt to install the desired version of the software application or package more directly by copying files for the software directly to the indicated system. It may also attempt to invoke an install process to install the desired version of software on the system. According to an embodiment, the testing framework may execute a system management process on the indicated system to perform some or all of these steps.

### Statistics-Related Tasks

A test job may also request the test administrator to perform certain tasks related to generating statistics and performance logs. The test job may, for instance, send test feedback to the test administrator requesting indicating a state event—i.e. that the test job has entered or left a certain state. The test administrator may be configured to maintain state data for a test job indicating when it entered into or left various states. It may then send this state data to a statistics collection component or test result generating component for use in generating a test result, as discussed in 4.8.

A test job may define any number of states, such as a ready state, busy state, steady state, execution state, and so on. For example, the test job may be said to have entered an execution state when it has finished completing certain initialization tasks for which performance statistics might be irrelevant. The test job may be said to have entered a busy state when processor usage is over a pre-determined percentage. The test job may be said to have entered an error state when a software error occurs. The test job may define other states related to specific software functionality, software interactions, or phases of software execution.

The test administrator may also be configured to, upon receiving test feedback indicating certain pre-defined states, send statistics instructions, such as statistics instructions 194, to performance monitoring components, such as profiler 195 or resource monitor 176, on a set of systems referred to collectively as statistics hosts. According to an embodiment, each system used to test software during the test job may be considered a statistics hosts. Alternatively, only certain systems used by the test job may be designated as statistics hosts. The test details may specify these statistics hosts in much the same way the test details may specify one or more execution hosts. Also, the test job itself may specify or determine a set of statistics hosts, and the test job may identify these statistics hosts to the test administrator.

The statistics instructions may include commands that cause a performance monitoring component to begin or end logging performance statistics. For example, in response to test feedback indicating an error state or busy state, the test administrator might be configured to send statistics instructions instructing a profiler to start logging data. As another example, in response to test feedback indicating a ready state, the test administrator might send statistics instructions to start logging to certain classes of performance monitoring components specified by the test feedback or test details. As another example, in response to test feedback indicating the end of a ready state, the test administrator might send statistics instructions instructing performance monitoring components to send logged data to statistics collector 114 or a central repository for collecting statistics on the execution host.

According to an embodiment, the test job may request for the test administrator to start profilers on one or more specific systems or on all systems used in the test job. In response, the test administrator may send statistics instructions to the indicated system or systems. The statistics instructions may include commands that, when executed by the receiving system, invoke a profiler.

According to an embodiment, a statistics collector may instead send the above-described statistics instructions. In response to receiving test feedback requesting performance of a statistics-related task, the test administrator may relay the request to the statistics collection component, such as statistics collector 114. The statistics collector may then perform the statistics-related task.

According to an embodiment, a statistics host may not necessarily be a system on which the tested software is executed. Rather, a statistics host may be a system running a process that allows it monitor and supervise generation of performance logs on other systems that are executing the tested software.

### Ending the Test Job

The test administrator may also be responsible for, upon detecting that the test job has completed, performing certain administrative tasks. It may detect completion of the test job by, for instance, monitoring the execution script process on the execution host. It may also monitor other test job processes. Or, the test job may send test feedback notifying the test administrator that the test job is complete.

If the test details originally received by the test administrator contained instructions or attributes indicating one or more commands to be executed on the execution host at the end of a test job, the test administrator may send test instructions to the execution host with these commands at this time. These commands may perform a variety of operations on collected performance logs. These commands may also clean up temporary files or restore the execution host's environment to its condition prior to when the test administrator invoked the test job.

The test administrator may also instruct the scheduler to unreserve the systems involved in the test job at this time, so that the scheduler may launch new test jobs from the test job queue.

The test administrator may also notify a user that the test job is complete via, for instance, an email message. The email message may include a link to an interface for viewing test results, such as the web interface discussed in section 4.9.

According to an embodiment, the test administrator may then instruct a statistics collector, such as statistics collector 114, to begin collecting and processing performance statistics generated during the test job. Collecting performance statistics is discussed in section 4.7, below.

### Sending Test Feedback Via the File System

According to an embodiment, a test job may deliver test feedback, such as test feedback 193, to the test administrator via a file system. The test job may create files in a file system that is accessible to both the test job and the test administrator. For example, the test job might write these files to a shared directory in a file system on system 170.

The test administrator may regularly monitor this shared directory for new files. The test administrator may interpret files with certain pre-defined names as testing feedback. For example, if it sees a file named START_PROFILER, the test administrator could interpret the file as test feedback requesting the test administrator to start profilers on systems used by the test job. Likewise, a file named BEGIN_EXECUTION_STATE might be interpreted as indicating a ready state.

The test job may also include test feedback within file contents. For example, it might use the contents of a START_PROFILER file to indicate the systems on which to start a profiler. Indeed, in some embodiments, the test job may communicate test feedback only through file contents—a file's name might only be relevant in that the file's name indicates to the test administrator that the file contains testing feedback. As another example, the test plan of the example execution script simple_test.pl, presented in section 4.1, comprises steps for a send_feedback routine that sends test feedback by writing files with specified names to the file system.

### 4.7. Collecting Statistics

According to an embodiment of the invention, the testing framework may feature a statistics collection component, such as statistics collector 114, to facilitate collection of logs, such as logs 160, reflecting the performance of systems used in a test job. The statistics collector may gather these logs throughout the test job, or it may simply gather logs when the test administrator indicates that test job is complete.

The test administrator may relay certain instructions to the statistics collector that enable it to determine what courses of action it should take to obtain these logs. These instructions may be derived from test details, test feedback, default testing framework settings, or any combination of the three. These instructions may identify, for instance, a list of statistics hosts, an execution host, the start and end time of the test job, the start and end time of certain states of the test job, whether profiling was enabled, the location of one or more shared repositories to which the statistics hosts or test job outputted logs, and so on. The statistics collector may be able to determine some of these details on its own-for instance, it may be able to determine start and end times from files used for test feedback within the shared repository.

According to an embodiment of the invention, at the end of a test job, the statistics collector requests performance logs from each of a variety of log-generating components implicated by the test job. The statistics collector may have access to, for instance, a list of statistics hosts. Alternatively, the statistics collector may be able to learn the list of statistics collectors for a test job by itself. The statistics collector may also have access to or derive a list of resource monitors and profilers running on each statistics host. The statistics collector may request, from each of these components, any logs they may have collected with metrics relevant to the test job. To allow the log-generating component to determine if a log is relevant, the statistics collector might identify a start time and end time. The start time and end time could be for the entire test job, or just for a period of time when the test job was in a specific state. The statistics collector may also attempt to collect logs from a shared directory on the network where, as indicated by test details or test feedback, the tested software or test job may have outputted logs.

According to an embodiment of the invention, much of the burden for collecting performance statistics may be shifted to the statistics host themselves. Each statistics host may run a process for collecting logs at that individual statistics host. The code for such a process may be provided by the testing framework. Upon receiving statistics instructions indicating the end of a test job (or indicating the end of a state of the test job for which the statistics host has been asked to collect data), the process on the statistics host may send the collected logs to the statistics collector. Alternatively, the process on the statistics host may send the logs to the execution host, to be stored in a centralized repository dedicated for the particular test job. For example, the process on the statistics host may send logs to the same shared folder where the test job's execution host creates files indicating test feedback.

According to an embodiment, the test plan may itself contain instructions for gathering logs from log generating components on each of the statistics hosts. For example, the test job may have invoked log-generating capabilities of the tested software. It may locate the generated logs and forward them to the statistics collector directly or place them in a centralized log repository for the test job.

### Default System Performance Statistics

According to an embodiment, the testing framework may collect a default set of system performance statistics from each statistics host for every test job it invokes, regardless of whether or not such statistics were explicitly requested. These default statistics might include, for instance, processor usage, memory usage, network utilization, virtual memory usage, a number of executing processes, hard disk usage, bus utilization, and so on.

The statistics collector may collect these statistics directly from resource monitors on the statistics host. For example, the statistics collector might collect statistics from a resource monitor embedded in a statistics host's operating system. Alternatively, processes initiated by the testing framework on each statistics host may gather these statistics.

According to an embodiment, the testing framework may collect the default set of system performance statistics from all systems in the test cluster, regardless of whether or not there is any indication that a particular system in the test cluster is involved in the test job. Statistics for systems not involved in the test job may be determined and removed during test result generation, or they may be preserved in the test result.

### 4.8. Generating a Test Result

After the statistics collector has collected any available logs—such as logs 160—the statistics collector may forward the logs to a test result generating component, such as test result generator 115. Alternatively, the statistics collector may return the logs to the test administrator or the test module, either of which may then forward them to the test result generator. The test result generator may then translate the logs into a test result.

As part of the test result, the test result generator may create any number of data reports, each of which may comprise data related to one or more performance metrics or events for which values were logged in the collected logs. Each data report may comprise time-series data, text-based log entries, or tabular data, along with metadata identifying, among other things, the relevant performance metrics.

The test result may be generated in a variety of forms. One form for storing test results may be a collection of data files on a file system. For example, each data report may be stored as a file named after metadata for the data report or the log that originated the data for the data report. To facilitate ease of browsing, these data files may be organized in a tree-like structure under a directory associated with the test job. Such a directory may be on a file system accessible to the testing framework or test module. Such a directory might be named, for example, after a test job identifier included in the test case or test details. The tree-like structure may include branches for each statistics host and each log-generating component. It may also include branches for data reports generated from aggregation or analysis.

The test result generator might alternatively store the test result as rows and tables in a database or as elements in an XML file based on a schema defined by the testing framework.

According to an embodiment, a simple test result may be generated simply by translating each collected log into a single data report. The contents of an individual log may become the data for an individual data report. The test result generator may generate metadata for the data report based on, for example, the file name of the log, a header inside of the log, or properties associated with a file containing the log.

According to an embodiment, the test result generator may create a more enhanced test result by performing a variety of operations on the logs, including filtering, aggregation, and analysis. The test result generator may perform these and other operations by default, or the test result generator may accept, with the logs, input from which the test result generator may determine which operations to perform and how to perform them. Said input may be derived, for example, from the test case or test details.

### Removing Irrelevant Data

One operation the test result generator might perform is filtering irrelevant data. Each row of the log may contain a timestamp indicating when an event occurred or a metric value was taken. When it received the logs, the test result generator may have also received data from the sending entity indicating a start time and end time for the test job. The test result generator may remove all rows of the log that do not fall between the start and end time.

In some cases, the start or end time used may be based on when the test job entered a certain state as opposed to when the test job actually started. The test result generator may have received data indicating a start and end time for a number of states of the test job. The test result generator may be configured to remove data that does not correspond to a particular state, such as an “execution” state. This particular state may be defined by default for the testing framework, or it may have been communicated in the test details to the test administrator, and then relayed to the test result generator.

### Re-Sampling the Data

Another operation the test result generator might perform is data re-sampling. A log may contain metric values that were taken at a certain frequency. The test result generator may receive input indicating that the test results should report metrics with at a lesser frequency. The test result generator may resample the metric values so that they are reported at the desired frequency in the data reports generated for the test result.

For example, a log may report metrics at every tenth of a second. The test case may have requested metrics to be reported at every second. The metrics may be re-sampled by averaging metric values over every ten rows of the log, and then outputting to the data report the average of the ten rows, along with the median timestamp for the ten rows.

In cases where more frequent reporting of a metric is desired than is stored in a log, the test generator may also be able to interpolate data for that metric, so as to help a user to guess what the value for that metric may have been at a specific time.

### Organizing Data by Test Job States

The test result generator may also organize data from the logs according to state data collected by the test administrator or statistics collector. The test result generator may subdivide a log into separate data reports for each state. Each data report may comprise only metric values that were taken or events that occurred while the test job was in the particular state of the data report. The metadata for each such data report may identify the state to which the data report pertains.

### Correlating Related Metrics

The test result generator may correlate certain metrics into a same data report. For example, there may be separate logs with time-series data pertaining to related metrics. The test result generator may output these metrics into a tabular format in a same data report, so that the metrics may be more easily correlated. Where the metric values were taken at different times or frequencies, merging the metrics may require, for instance, re-sampling the metrics or adjusting the timestamps for a metric.

The test result generator may also perform calculations based on the related metrics, so as to better identify a correlation between the metrics. For example, memory usage might be divided by a thread count to derive a data report reflecting the average amount of memory used by each thread on a system. The metadata for such a correlated data report might identify a title such as “Memory per Thread.” The metadata might also identify data reports for the individual metrics “Memory” and “Thread,” so as to all allow a user to drill-down into greater detail.

### Aggregating Statistics Across Systems

The test result generator may also generate aggregated data reports across multiple systems. The test result generator may identify logs (or already-generated data reports) from different systems that measure the same metric. If the metrics in each log were sampled at the same approximate times with the same frequency, the test result generator may generate an aggregated data report simply by averaging the metric values from each system for each particular time. If the metrics were sampled at different times or at different intervals, the test result generator might employ a number of operations to aggregate them, such as re-sampling the metrics and then averaging them.

### Translating Logs into Graph-Viewable Statistics

The test result generator may also employ techniques to translate certain event-based logs into data reports that may be graphically visualized. For example, a log-generating component may have outputted a line to a log every time a certain event occurred. The test result generator may determine from these events the number of times an event occurred each second. It may output a row in a data report with a timestamp for each second of the test job and the number of events that occurred in that second. Thus, the data report may later be visualized as a graph depicting the number of events per second.

### Highlighting Key Statistics

The test result generator may analyze metric values in a particular data report to determine standard statistics of interest for that data report, including the mean value, minimum value, maximum value, standard deviation, and so on. These values may be stored for later use as metadata for the data report.

### Highlighting Significant of Unexpected Results

The test result generator may also employ analysis techniques to highlight significant or unexpected results in the data. It may include in the test results a list of data reports containing such significant or unexpected results.

For example, the test result generator may be configured to highlight metrics whose values change more than a certain predefined percentage over the course of a test job. As another example, the test result generator may be configured to highlight metrics with values that exceed a standard deviation.

As another example, the test result generator may have received instructions indicating a certain threshold for a particular metric. This threshold may have been specified in the test details. For example, the user may have submitted this threshold as part of the test case. Or, the test module may have determined this threshold by analyzing values for the metric in previously executed test jobs. If the threshold is exceeded for a metric in a particular data report, the test result generator may add that data report to the list of significant or unexpected results.

### 4.9. Presenting a Test Result

According to an embodiment, a test result, such as test result 155, may be returned to the test module. The user may, through an interface for the test module, request to view the test results. The test module may utilize a reporting component, such as test reporter 116, to generate an interface for the test module.

The test reporter may be or use any graphical or textual interface. The test reporter may generate graph, table, and textual views based on the data reports in a test result. The test reporter may organize these views in a variety of ways, so as to allow a user to access the data more quickly. The test reporter may feature a variety of interactive controls for performing further operations on test result data and building additional data reports.

### Exemplary Web Interface

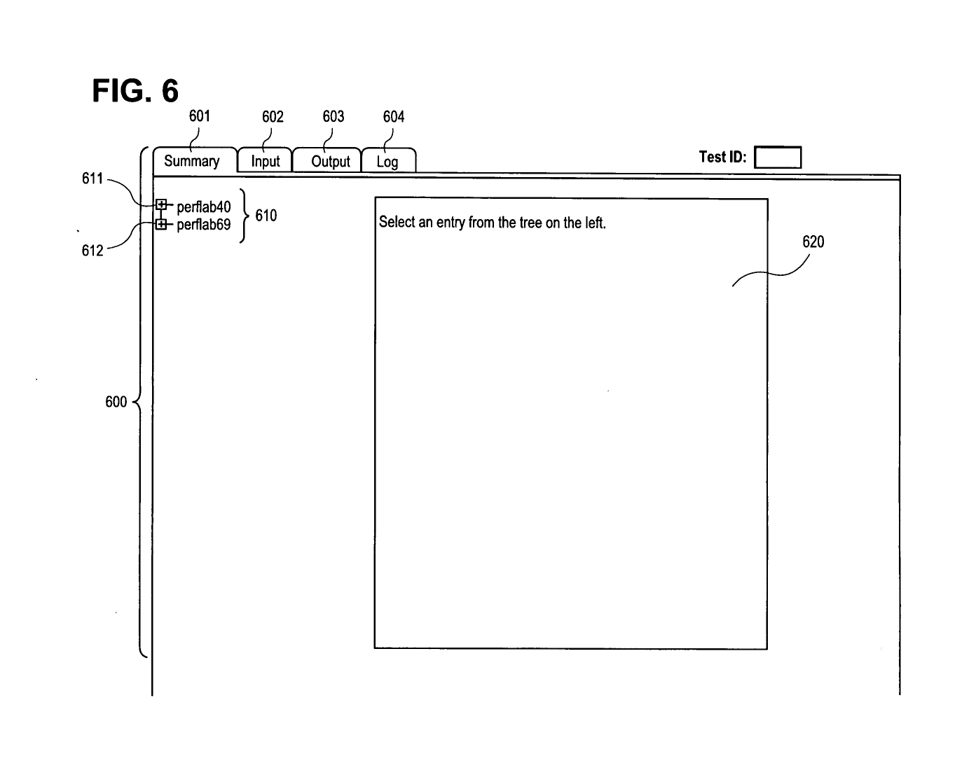

FIGS. 6-10 illustrate an exemplary interface that may be generated by test reporter 116. The organization and presentation of a test result in FIGS. 6-9 is exemplary only, and may vary significantly from test job to test job and test module to test module. A variety of other techniques to organize and visualize a test result may be used instead.

FIG. 6 depicts an exemplary web interface 600 for presenting a test result, according to an embodiment of the invention. Web interface comprises a control 608 for inputting an identifier of a test job-for instance, the identifier specified in control 401 of web interface 400. Once a test job is selected using control 608, web interface 600 may display tabs, such as tabs 601-604. Each of tabs 601-604 may provide a view of information associated with the selected test job. For example, when clicked, tab 601 may depict information entered for the test case that spawned the test job.

If test results have been determined for the selected test job, a user may click on tabs 603 and 604 to view the test results. Tab 603 may be used to browse graphical displays of the data reports in test result 603. Tab 604 may be used to browse textual displays of data reports in test result 604.

### Organization of the Test Result

Tree 610 is a tree-like structure that may be used for locating and browsing specific types of data reports for specific systems. For example, tree 610 may be used to browse a test result generated for a test job based upon the test case specified in web interface 400. As indicated in control 414, the test job that resulted from this test case used only two statistics hosts, each of which are listed in the test result as branches 611 and 612 of tree 610, respectively. If the test results had included data aggregated across systems, the tree might also include a branch for selecting such data.

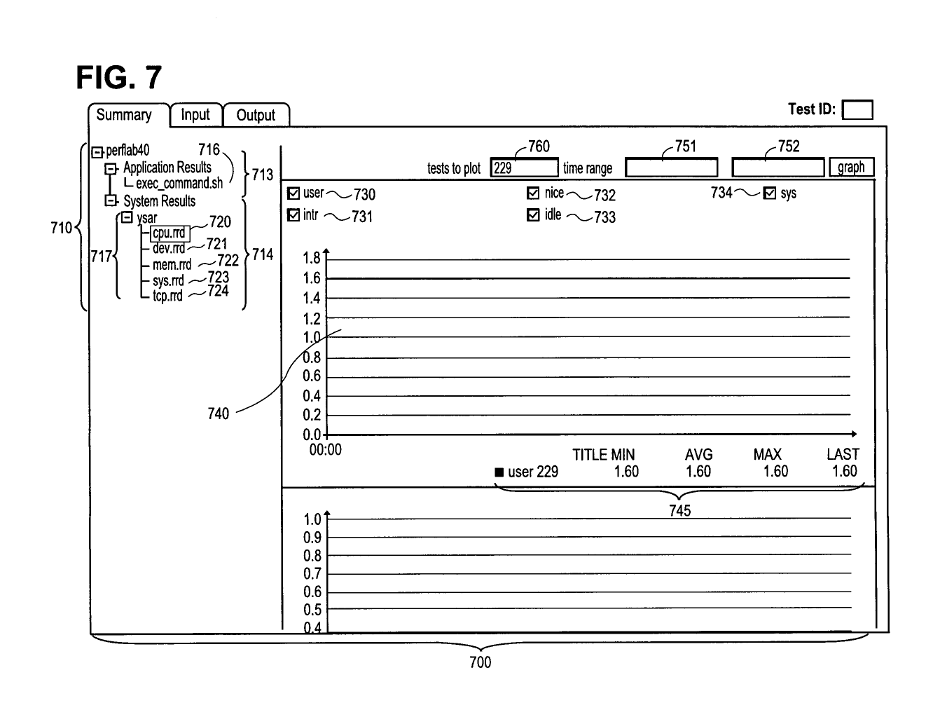

FIG. 7 depicts an exemplary web interface 700 for viewing graphical representations of data reports in a test result, according to an embodiment of the invention. Web interface 700 depicts the reaction of web interface 600 to a user expanding branch 611 of tree 610. Tree 710 is an expanded view of the branch 611. All data reports under this branch pertain to the system named perflab40.

Tree 710 comprises two sub-branches: Application Results 713 and System Results 714. These sub-branches organize the data reports for perflab40 by types of log-generating components. Application Results 713 correspond to logs generated by the tested software, while System Results 714 correspond to default system statistics collected for perflab40. According to an embodiment, tree 710 might comprise other sub-branches for other test jobs that utilize other types of log-generating components, such as a profiler.

Each of the sub-branches comprise additional sub-branches that more specifically identify the log-generating component that originated the data reports of the test result. For example, sub-branch 715 identifies the software component exec_command.sh as the source of its statistics, while sub-branch 716 identifies the ysar resource monitor as a source of System Results 714. Sub-branch 716 is be further organized into 5 sub-branches 720-724, each of which correspond to a different round-robin data file outputted as a log from the ysar resource monitor.

### Determining How to Visually Represent a Data Report

According to an embodiment, a test reporter may determine how to visually represent data reports by analyzing the data in the data report. Data reports with a row containing time stamps might be treated as time-series data and graphed accordingly. Other data in a tabular format (i.e. having rows and columns) might be treated as tabular data and graphed with a table, bar chart, or pie chart. Data in a non-tabular format might be depicted as a plain-text log.

Alternatively, a test reporter may use a file extension associated with the log originating the data for a data report to determine the correct visual presentation of the data report. For example, data reports with a .rrd extensions might be treated as time-series data. Data reports with a .csv extension might be treated as tabular data. Data reports with a .log extension might be treated as plain text logs.

Graph views of data reports in a test result may be generated by any graphing utility capable of transforming time-series or CSV data reports of the test result into graphs. For example, graphs may be generated by plotting a data report with gnuplot.

### Viewing Time-Series Based Data

In web interface 700, sub-branch 720 is currently selected. Sub-branch 720 comprises data reports for 5 different metrics, each of which may be depicted as a graph by checking a corresponding metric selection control 730-734. Graph 740 is a time-series graph of the values for the “user” metric, which plots user processor utilization on perfab40 during the course of the test job. Though not depicted, web interface may also comprise graph views of data corresponding to the other metric selection controls 731-734.

According to an embodiment, web interface 700 may also feature controls that allow a user to overlay data reports in the same graph. For example, web interface 700 might feature drop-down or checkbox selectors next to graph 740. These selectors might allow a user to select one or more other data reports to plot on graph 740. In this manner, the user could more easily spot correlations between data.

### Viewing Tabular Data

According to an embodiment, web interface 700 may also be used to view data reports in tabular format, such as CSV. The test reporter may render such data reports as a table. Alternatively, web interface 700 may try to render the data report as a bar graph, pie graph, or any other type of graph.

If the data report contains a timestamp column, the test reporter may render each column of the data report as separate metrics in the same graph. Or, the test reporter may treat each column in the data report as a separate time-series graph that may be separately viewed and enabled.

Alternatively, a web interface for viewing a test result may feature a control that allows a user to choose between a table, time-series graph, or other type of graph for viewing the data report.

### Viewing Plain Test Logs

Certain data reports may not translate well visually. For example, a log of events or debug output may contain a number of unrelated statements. These statements may still be important to the test result. Thus, the test reporter may allow a user to directly view the contents of these logs.

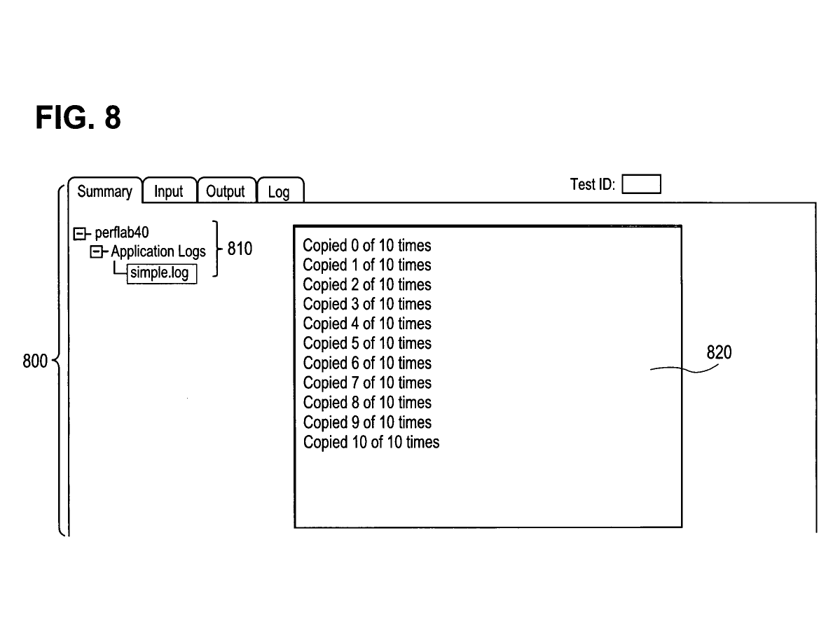

FIG. 8 depicts an exemplary web interface 800 for viewing text-based data reports in a test result, according to an embodiment of the invention. A user may have arrived at web interface 800, for instance, by clicking on tab 604 of web interface 600. Like web interface 700, web interface 800 features a tree-like structure for organizing data reports by system and log-generating components. This tree-like structure is tree 810. Tree 810 comprises only text-based data reports that cannot be visualized graphically; however, a test reporter might also offer plain text views for data reports that can be viewed graphically.

As indicated by tree 810, web interface 800 is depicted as visualizing a data report derived from a software-generated log named simple.log. Box 820 is a scrollable text box that displays this data report as plain text.

### Identifying Key Statistics for a Data Report

Below graph 740 is a list of key statistics indicators 745 that depict statistics that may have been incorporated into metadata for graph 740's data report, such as mean values, maximum values, and minimum values. According to an embodiment, these values may be indicated with colors or symbols on graph 740 itself.

### Filtering Data

An interface for presenting a test result may also comprise controls that filter the presentation of data in the data reports. Controls 751 and 752, for example, allow a user to limit the time range of the data plotted.

Web interface 700 also might feature other controls that, when clicked, cause the test reporter to perform analyses and aggregation operations similar to those explained in section 4.8. The test reporter may display the results of these analyses and aggregation operations in another window of web interface 700.

### Comparing Results form Other Test Jobs

According to an embodiment, test results from a test job may be saved for future viewing and analysis against test results from future test jobs. For any data report in a new test result, a test reporter may automatically look for data reports of a similar metrics in previously stored test results. It might overlay graphs for similar metrics in previous test results on top of graphs of similar metrics in the new test result for comparison. In this manner, the web interface may help a user identify trends in metrics between test results for test jobs based on similar test cases. The web interface may even comprise a summary page that shows graphs and other information for metrics whose values were significantly different in one or more previous test results.

According to one embodiment, the test reporter might be able to identify test results with data reports of similar metrics based on the organization of the test results. Alternatively, the test reporter may automatically assume that test results for test jobs based on a same template test case have similar data reports.

A user may also select previous test results for comparison, as depicted in web interface 700. Control 760 allows a user to identify a comma separated list of other test jobs. If the test results for any of these other test jobs comprises data reports based on metrics similar to those currently being viewed (for example, if the test result also has user processor utilization data for perflab40), the test reporter may overlay those data reports on top of the corresponding graph in web interface 700.

### Additional Exemplary Interface

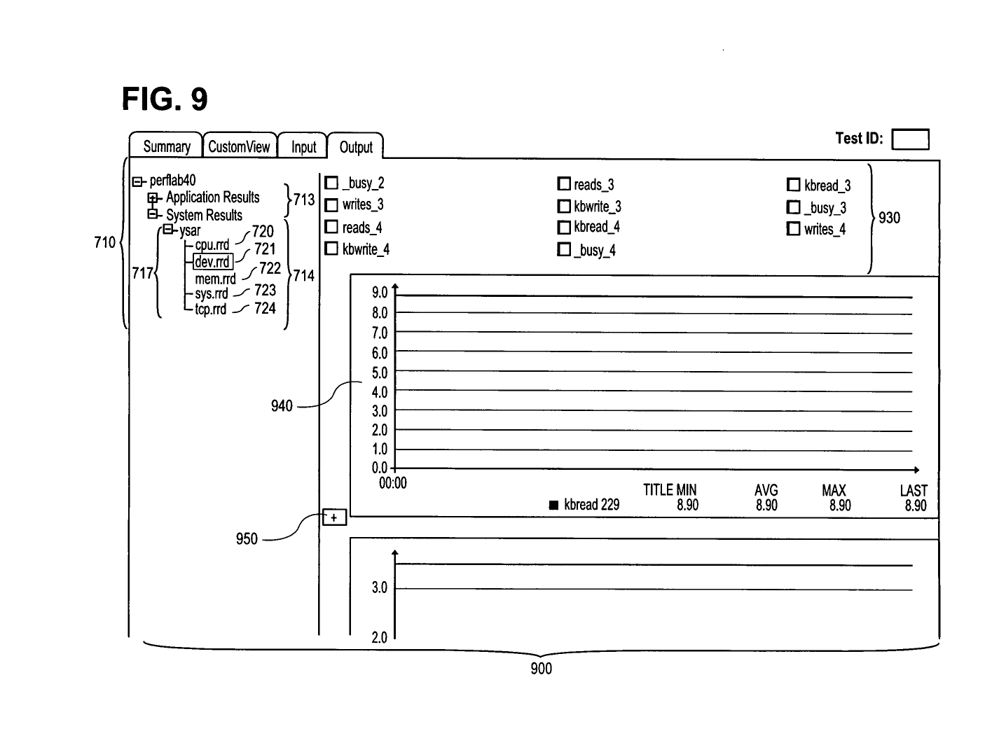

FIG. 9 depicts an exemplary web interface 900 for viewing graphical representations of data reports in a test result, according to an embodiment of the invention. FIG. 9 is like FIG. 7, except that it depicts how data reports may be graphed for a different sub-branch 721. Thus, FIG. 9 comprises a different set of metric selection controls 930 that correspond to metrics for data reports that may be visualized using different graphs, such as graph 940.

### Identifying Unexpected Trends

According to an embodiment, when no branch of the tree is selected, as in FIG. 6, a main view pane 620 might include links to graphs depicting data reports with significant or unexpected data. Main view pane 620 might also include graphs for depicting these data reports directly. Main view pane 620 might also include graphs of metrics that have been identified as significant for the test job or for previous test jobs.

### Reporting Plugins

According to an embodiment, a testing framework or test module may provide an extensible API for creating plugins that generate additional views of individual data reports. For example, an installed plugin might expose a control next to the default view of each data report in the test result. The control might be a button that, when clicked, pops up a window with an alternative view of the data report. Such an alternative view might be, for example, a different graph type or a special textual display. Such an alternate view might also filter the data report or display data derived from analytical operations performed with respect to the data report.

### Statistics Shopping Cart

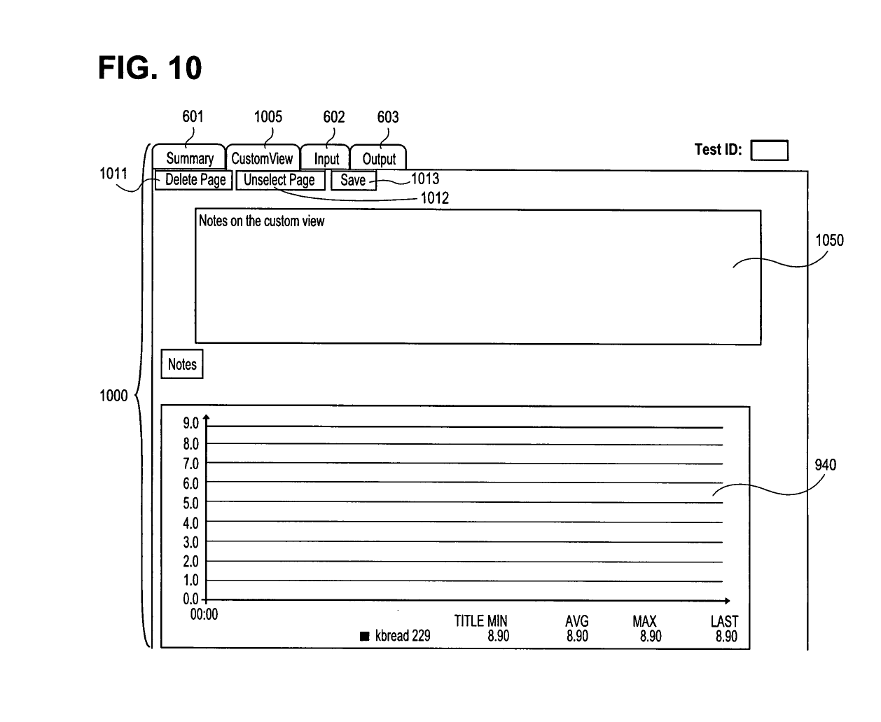

FIG. 10 is an exemplary web interface 1000 for building a custom view of data in a test result using a shopping cart model, according to an embodiment of the invention. Such a custom view may be accessible, for instance, via a custom view tab 1005, similar to tabs 601, 602, 603, and 604 of web interface 600.

As depicted in FIGS. 7 and 8, each rendered data report, whether it be a graph, table, or textbox, may include a checkbox control. Web interface 700, 800, or 900 may be configured to include a button that adds data reports whose checkboxes have been checked to a custom view, such as depicted in FIG. 10. For example, graph 940 from web interface 900 may have been added to the custom view depicted in web interface 1000 by button 950. Web interface 1000 may include many additional graphs added through such means.

A custom view may be saved for reference the next time a user views the test result. Web interface 1000 includes controls 1011, 1012, and 1013 for deleting, unselecting, and saving the custom view of web interface 1000, respectively. Web interface 1000 might also include a control for printing the custom view. Web interface 1000 also includes a notes box 1050 to allow a user to enter notes for future reference. A user may create and save any number of such custom views, each with a different title.

According to an embodiment, custom views are associated with a test module, as opposed to a single test result. Once saved, a custom view may be shown for all test results generated for that test module. When a user saves a custom view, a test module may save metadata indicating the metric or metrics logged by each data report in the custom view. For any subsequent test result, the test reporter may use this metadata to determine data reports to show in a custom view for the subsequent test result.

For example, a user might create a custom view that comprises a graph depicting processor utilization for a first test result. When the user saves this custom view, the test module may store information indicating that the custom view comprised a graph for a processor utilization metric. When the user views a subsequent test result, the test reporter may automatically generate a corresponding custom view for the subsequent test result. The corresponding custom view may include a graph depicting processor utilization for the second test result. If the subsequent test result does not contain a data report for a processor utilization metric, the custom view for the subsequent test result may simply not include a graph for the processor utilization metric.

According to an embodiment, saved custom views may be associated with a test case template as opposed to the test module in general, meaning that any test result generated for test jobs based on the same test case template may automatically include a custom view that was saved for another test result generated for another test job based on the same test case template. Test case templates are discussed in section 4.3.

### 4.10. Operating System Independence

According to an embodiment of the invention, various aspects of the testing framework are platform-independent, meaning that the testing framework may be deployed on a test cluster with systems that run a variety of operating systems.

According to an embodiment, the testing framework may comprise code that is able to automatically detect the operating system of execution hosts and statistics hosts. When sending test instructions or statistics instructions to an operating system itself-via, for instance, a secure shell or telnet session-the testing framework may issue commands or reformat commands in a format that may be executed on the detected operating system.

According to an embodiment, the testing framework may be configured to automatically search for resource monitoring or profiling components on each system in the test cluster. The testing framework may comprise a list of multiple profilers or resource monitoring components which may be used on the operating system of the particular system. The testing framework may search for each component in the list, or stop searching when it finds a first acceptable component. It may, for instance, search one or more default locations in a file system to locate an executable file for a particular profiler or resource monitoring component. It may then invoke this executable. It may also use, for example, a system registry to locate the particular profiler or resource monitoring application.

According to an embodiment, the testing framework may be configured to install its own profiling or resource monitoring components on each system in the test cluster, thereby ensuring that it will be able to access a profiling or resource monitoring component on each of the systems. According to an embodiment, whenever a statistics host is identified in test details, if the testing framework is unable to locate an appropriate profiler or resource monitoring component, the testing framework may install its own profiling or resource monitoring component on the statistics host. For each operating system running on a system in the test cluster, the testing framework may store installers for profiling and resource monitoring components that run on the operating system.

According to an embodiment, the testing framework may be configured to communicate with and understand logs generated by at least one profiler and resource monitoring component on each operating system in the test cluster. It may know, for instance, the configuration parameters necessary to control each profiling or resource monitoring component. Or, it may know how to send commands to a dedicated port for each profiling or resource monitoring components. It may also know a default location where the profiling or resource monitoring component stores its logs.

According to an embodiment, each system in the testing framework may run a management process administered by the testing framework. Instead of needing to know how to remotely communicate with a system's operating system and log-generating components, the testing framework may communicate with this process instead. This process may then be configured to locally communicate with the operating system and log-generating components on behalf of the testing framework.

According to an embodiment, the interfaces for the testing framework and the test module may be platform-independent. For example, the interface may be a web interface, such as those depicted in FIGS. 3-8, which may be viewed in web browsers on any operating system. Alternatively, the interface may be in some other universally-readable form, such as a Java-based client.

According to an embodiment, each component of the testing framework may also be platform-independent, in that it is coded in a language, such as Java, that may be compiled and executed on any operating system without changes. Alternatively, the code for the testing-framework may have been ported, for each operating system, to a language that may be compiled and executed on the operating system.

### 4.11. Real-Time Monitoring

According to an embodiment, the statistics collector may collect logs in real-time. The test result generator may create real-time test results, which may then be reported in real-time by the test reporter. Such real-time reporting may allow a user to more easily determine the cause of bugs and inefficiencies in the tested software, as the user may be alerted to their effects as the effects occur.

Additionally, the test reporter may generate an interactive interface for real-time reporting of test results that allows a user to dynamically change some of the conditions of the test case. For example, the real-time interactive interface may feature an “enable profiling” button. A user might click this button in response to observing a real-time result. The test module may then send new test details to the test administrator. Recognizing that the new test details have a test job identifier equal to an already executing test job, the test administrator may send supplemental test instructions or statistics instructions to the execution hosts or statistics hosts involved in the test job that cause them to begin profiling the already executing test job.

### 5.0. Implementation Mechanism-Hardware Overview

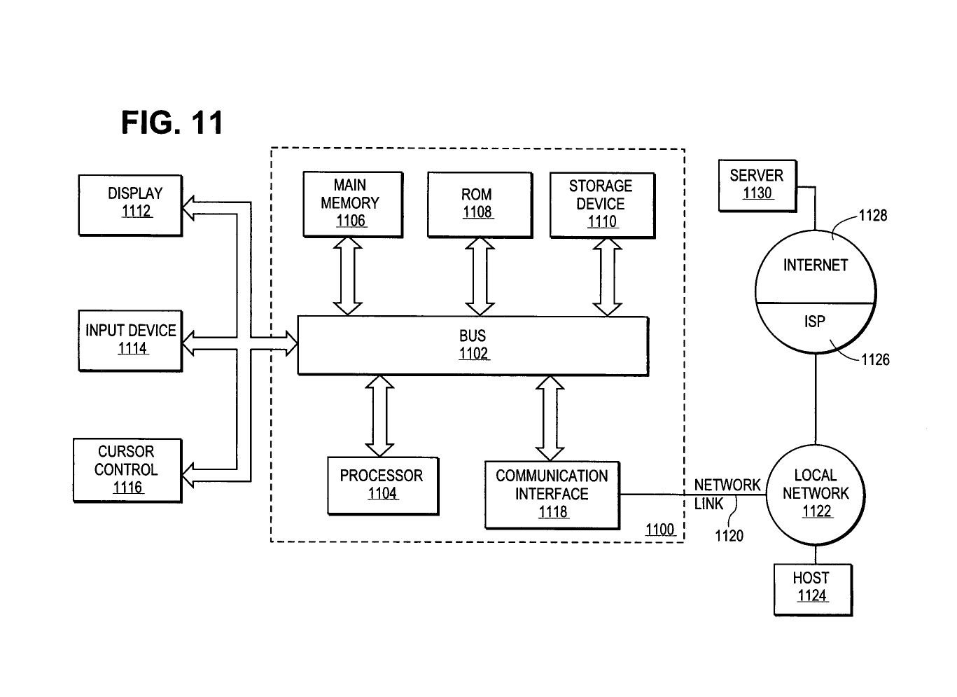

FIG. 11 is a block diagram that illustrates a computer system 1100 upon which an embodiment of the invention may be implemented. Computer system 1100 includes a bus 1102 or other communication mechanism for communicating information, and a processor 1104 coupled with bus 1102 for processing information. Computer system 1100 also includes a main memory 1106, such as a random access memory (RAM) or other dynamic storage device, coupled to bus 1102 for storing information and instructions to be executed by processor 1104. Main memory 1106 also may be used for storing temporary variables or other intermediate information during execution of instructions to be executed by processor 1104. Computer system 1100 further includes a read only memory (ROM) 1108 or other static storage device coupled to bus 1102 for storing static information and instructions for processor 1104. A storage device 1110, such as a magnetic disk or optical disk, is provided and coupled to bus 1102 for storing information and instructions.

Computer system 1100 may be coupled via bus 1102 to a display 1112, such as a cathode ray tube (CRT), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. This input device typically has two degrees of freedom in two axes, a first axis (e.g., x) and a second axis (e.g., y), that allows the device to specify positions in a plane.

The invention is related to the use of computer system 1100 for implementing the techniques described herein. According to one embodiment of the invention, those techniques are performed by computer system 1100 in response to processor 1104 executing one or more sequences of one or more instructions contained in main memory 1106. Such instructions may be read into main memory 1106 from another machine-readable medium, such as storage device 1110. Execution of the sequences of instructions contained in main memory 1106 causes processor 1104 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 1100, various machine-readable media are involved, for example, in providing instructions to processor 1104 for execution. Such a medium may take many forms, including but not limited to storage media and transmission media. Storage media includes both non-volatile media and volatile media. Non-volatile media includes, for example, optical or magnetic disks, such as storage device 1110. Volatile media includes dynamic memory, such as main memory 1106. Transmission media includes coaxial cables, copper wire and fiber optics, including the wires that comprise bus 1102. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 1104 for execution. For example, the instructions may initially be carried on a magnetic disk of a remote computer. The remote computer can load the instructions into its dynamic memory and send the instructions over a telephone line using a modem. A modem local to computer system 1100 can receive the data on the telephone line and use an infra-red transmitter to convert the data to an infra-red signal. An infra-red detector can receive the data carried in the infra-red signal and appropriate circuitry can place the data on bus 1102. Bus 1102 carries the data to main memory 1106, from which processor 1104 retrieves and executes the instructions. The instructions received by main memory 1106 may optionally be stored on storage device 1110 either before or after execution by processor 1104.

Computer system 1100 also includes a communication interface 1118 coupled to bus 1102. Communication interface 1118 provides a two-way data communication coupling to a network link 1120 that is connected to a local network 1122. For example, communication interface 1118 may be an integrated services digital network (ISDN) card or a modem to provide a data communication connection to a corresponding type of telephone line. As another example, communication interface 1118 may be a local area network (LAN) card to provide a data communication connection to a compatible LAN. Wireless links may also be implemented. In any such implementation, communication interface 1118 sends and receives electrical, electromagnetic or optical signals that carry digital data streams representing various types of information.

Network link 1120 typically provides data communication through one or more networks to other data devices. For example, network link 1120 may provide a connection through local network 1122 to a host computer 1124 or to data equipment operated by an Internet Service Provider (ISP) 1126. ISP 1126 in turn provides data communication services through the world wide packet data communication network now commonly referred to as the “Internet” 1128. Local network 1122 and Internet 1128 both use electrical, electromagnetic or optical signals that carry digital data streams. The signals through the various networks and the signals on network link 1120 and through communication interface 1118, which carry the digital data to and from computer system 1100, are exemplary forms of carrier waves transporting the information.

Computer system 1100 can send messages and receive data, including program code, through the network(s), network link 1120 and communication interface 1118. In the Internet example, a server 1130 might transmit a requested code for an application program through Internet 1128, ISP 1126, local network 1122 and communication interface 1118.

The received code may be executed by processor 1104 as it is received, and/or stored in storage device 1110, or other non-volatile storage for later execution. In this manner, computer system 1100 may obtain application code in the form of a carrier wave.

### 6.0. Extensions and Alternatives

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method for testing application performance comprising the steps of:
receiving, at a testing framework, input identifying (a) a test plan for testing specific software, and (b) one or more attributes;
wherein the one or more attributes define input parameters for a test module for said software;
based on said one or more attributes, a test module generator within the testing framework generating said test module for testing performance of the specific software;
wherein the test module generated by the test module generator is configured to receive values for the input parameters defined by the one or more attributes;
executing a test job during which said test module initiates execution of the test plan based on specific values for said input parameters; and
the testing framework gathering performance statistics related to execution of the software.

2. The method of claim 1 wherein:
the specific software is first specific software;
the test module is a first test module; and
the method further comprises:
receiving, at said testing framework, input identifying (a) a second test plan for testing said second specific software, and (b) a second set of one or more attributes;
wherein the second set of one or more attributes define second input parameters for a second test module for said second specific software;
based on said second set of one or more attributes, said test module generator within the testing framework generating said second test module for testing performance of said second specific software;
wherein the second test module is configured to receive values for the second input parameters;
executing a second test job during which said second test module initiates execution of said second test plan based on specific values for said second input parameters; and
the testing framework gathering performance statistics related to execution of the second specified software.

3. The method of claim 2 wherein:
during execution of the first test job, the first specific software executes on a first machine that has a first operating system; and
during execution of the second test job, the second specific software executes on second machine that has a second operating system that is different from the first operating system.

4. The method of claim 1 further comprising the steps of:
executing a second test job during which said test module initiates execution of the test plan based on a second set of specific values for said input parameters; and
the testing framework gathering a second set of performance statistics related to execution of the software.

5. The method of claim 4 further comprising the step of said testing framework generating a user interface for said test module, wherein said user interface features controls for comparing performance statistics for the test job with the second set of performance statistics for the second test job.

6. The method of claim 1 comprising the step of said testing framework generating a user interface for the test module, wherein the user interface comprises controls for specifying said specific values for said input parameters.

7. The method of claim 1 wherein said specific values for said input parameters are based on values stored by the test module in a template.

8. The method of claim 1 the step of said testing framework gathering performance statistics comprises the step of said testing framework determining (a) a set of performance metrics to gather and (b) a set of systems from which to gather said set of performance metrics, wherein said determining is based on at least one of said specific values.

9. The method of claim 1 the step of said testing framework gathering performance statistics comprises the step of said testing framework determining (a) a set of performance metrics to gather and (b) a set of systems from which to gather said set of performance metrics, wherein said determining is not based on the set of said specific values.

10. A computer-implemented method for displaying a test result, comprising the steps of:
displaying a plurality of data reports, each of said data reports belonging to said test result;
displaying one or more controls for associating data reports with a custom view;
via one of said one or more controls, receiving input associating a first data report with said custom view of said test result;
via one of said one or more controls, receiving input identifying a second data report with said custom view of said test result;
receiving a request to display the custom view of said test result;
displaying the custom view of said test result, wherein said custom view includes the first data report and the second data report.

11. The computer-implemented method of claim 10 further comprising the steps of:
in response to receiving input associating said first data with said custom view, storing first custom view template information,
wherein said first custom view template information comprises data indicating a first performance metric for which said first data report comprises values;
in response to receiving input associating said second data with said custom view, storing second custom view template information,
wherein said second custom view template information comprises data indicating a second performance metric for which said second data report comprises values; and
in response to a request to display data from a second test result, automatically generating a second custom view,
wherein the second custom view comprises a third data report from said second test result, wherein the third data report comprises values for the first performance metric;
wherein the second custom view comprises a fourth data report from said second test result, wherein the fourth data report comprises values for the second performance metric.

12. A computer-readable storage medium storing one or more sequences of instructions which, when executed by one or more processors, causes the one or more processors to perform the method recited in claim 1.

13. A computer-readable storage medium storing one or more sequences of instructions which, when executed by one or more processors, causes the one or more processors to perform the method recited in claim 2.

14. A computer-readable storage medium storing one or more sequences of instructions which, when executed by one or more processors, causes the one or more processors to perform the method recited in claim 3.

15. A computer-readable storage medium storing one or more sequences of instructions which, when executed by one or more processors, causes the one or more processors to perform the method recited in claim 4.

16. A computer-readable storage medium storing one or more sequences of instructions which, when executed by one or more processors, causes the one or more processors to perform the method recited in claim 5.

17. A computer-readable storage medium storing one or more sequences of instructions which, when executed by one or more processors, causes the one or more processors to perform the method recited in claim 6.

18. A computer-readable storage medium storing one or more sequences of instructions which, when executed by one or more processors, causes the one or more processors to perform the method recited in claim 7.

19. A computer-readable storage medium storing one or more sequences of instructions which, when executed by one or more processors, causes the one or more processors to perform the method recited in claim 8.

20. A computer-readable storage medium storing one or more sequences of instructions which, when executed by one or more processors, causes the one or more processors to perform the method recited in claim 9.

21. A computer-readable storage medium storing one or more sequences of instructions which, when executed by one or more processors, causes the one or more processors to perform the method recited in claim 10.

22. A computer-readable storage medium storing one or more sequences of instructions which, when executed by one or more processors, causes the one or more processors to perform the method recited in claim 11.
